(19) United States
(12) Patent Application Publication
(10) Pub. No.: US 2026/0242643 A1
(43) Pub. Date: Aug. 20, 2026

(54) HYDROGEN BONDING BOTTLEBRUSH POLYMERS

(71) Applicant: The Regents of the University of California, Oakland, CA (US)

(72) Inventors: Christopher Bates, Santa Barbara, CA (US); Michael L. Chabinyc, Santa Barbara, CA (US); Intanon Lapkriengkri, Santa Barbara, CA (US); Renxuan Xie, Goleta, CA (US); Sanjoy Mukherjee, Goleta, CA (US)

(73) Assignee: The Regents of the University of California, Oakland, CA (US)

(21) Appl. No.: 18/993,980

(22) PCT Filed: Jul. 26, 2023
(86) PCT No.: PCT/US23/71063

§ 371 Date: Jan. 13, 2025

Related U.S. Application Data
(60) Provisional application No. 63/392,363, filed on Jul. 26, 2022.

(51) Int. Cl. C09J 151/08; C08F 290/06

(52) U.S. Cl. CPC C09J 151/08; C08F 290/061; C08F 2810/20

(57) ABSTRACT

A composition of matter, including a plurality of bottlebrush polymers, each of the bottlebrush polymers including a backbone including a plurality of monomer units; and a plurality of side-chains attached to the backbone; and one or more of the side-chains each comprising a linker compound terminated with a cross-linker compound comprising a hydrogen bonding group. A plurality of hydrogen bonds form reversible bonds between the hydrogen bonding groups of cross-linker compounds in different ones of the bottlebrush polymers, so as to form cross-links between different ones of the bottlebrush polymers. Comprising at least one of a glass transition temperature Tg or a melting temperature Tm below minus twenty degrees Celsius so that the composition of matter is amorphous and/or comprises an elastomer having at least one of a modulus less than 1 MPa at a temperature 23° C. or a melting temperature Tm less than 30° C.

### CROSS REFERENCE TO RELATED APPLICATIONS

This application claims the benefit under 35 U.S.C. Section 119(e) of U.S. Provisional Application No. 63/392,363, filed Jul. 26, 2022, by Christopher Bates, Michael Chabinyc, Intanon Lapkriengkri, Renxuan Xie, and Sanjoy Mukherjee, entitled “HYDROGEN BONDING BOTTLEBRUSH POLYMERS,” which application is incorporated by reference herein.

### BACKGROUND OF THE INVENTION

### 1. Field of the Invention

The present disclosure relates to bottlebrush polymers and methods of making the same.

### 2. Description of the Related Art

Associative dynamic polymer networks have attracted many research interests in recent years. The dynamic nature of the intermolecular network results from the temperature-activated dissociation of physical interactions or reconfiguration of covalent bonds. The latter, known as the covalent adaptive networks (CANs), has the advantage of retaining the mechanical properties of thermosets while allowing for efficient reprocessing of the materials. Nevertheless, CANs typically require relatively high self-healing temperatures to activate the bond exchanging process at the crosslink site, e.g., 160° C. via transesterification.¹ On the other hand, the physically associative networks via hydrogen-bonding or ionic interactions can dissociate and heal at milder conditions (typically <100° C.) due to a much lower binding energy.^{2,3} However, more apparent creep behavior is expected as the dissociation rate increases with temperature, thus limiting its elastomeric performance at room temperature. Recently, by coupling the dynamics of ionic groups near the end of a linear chain, the elastic plateau region can be extended by decades in frequency, thus expecting to reduce the creep in ionomer networks drastically.^{4,5} Yet to the best of our knowledge, no reports are found discussing the impact of chain architecture on the dynamics of hydrogen-bonding or ionic polymer networks.

Among various architectures (e.g., star, cycle), bottlebrush polymers offer versatile sidechain chemistries and allow access to the “super-soft” network modulus, complementing the goal of lowering the self-healing temperature for bio-related applications, such as wound dressing.^{6,7} Work on improving the processability of bottlebrush polymers could also enable new applications with customized 3D objects.⁸⁻¹¹ Furthermore, the coupled dissociation dynamics could be strongly affected by attaching the associative groups to the end of the protruding sidechain from each backbone repeat unit. These long sidechains also act as “diluents.” that drastically lower the entanglement density of the backbone and eliminate the complication of entangled associative networks.¹² Therefore, although covalently or dynamically crosslinked bottlebrush networks^{1,12-14} have been studied extensively for biomimetic, sensory, and adhesive applications, the bottlebrush network formed by hydrogen bonds remains unexplored and deserves investigation as a super-soft elastomer that self-heals easily. Some works on forming supramolecular bottlebrush polymer via a hydrogen-bonded backbone have been reported but not in the context of an elastomeric network.¹⁵⁻¹⁷. What is needed, then, are elastomeric materials that take advantage of the properties of bottlebrush polymers. The present invention satisfies this need.

### SUMMARY OF THE INVENTION

Illustrative embodiments of the inventive subject matter disclosed herein include, but are not limited to, the following.

1. A composition of matter, comprising:
a plurality of bottlebrush polymers, each of the bottlebrush polymers comprising:
   a backbone including a plurality of monomer units; and
   a plurality of side-chains attached to the backbone; and
   one or more of the side-chains each comprising a linker compound terminated with a cross-linker compound comprising a hydrogen bonding group; and
a plurality of hydrogen bonds forming reversible bonds between the hydrogen bonding groups of cross-linker compounds in different ones of the bottlebrush polymers, so as to form cross-links between different ones of the bottlebrush polymers; and
wherein a concentration of the hydrogen bonds is tuned and the one or more of the side-chains each have at least one of a glass transition temperature T_{g} or a melting temperature Tₘ below minus twenty degrees Celsius so that the composition of matter is amorphous and/or comprises an elastomer having at least one of a modulus less than 1 MPa at a temperature 23° C. or a melting temperature Tm less than 30° C.

2. The composition of matter of example 1, wherein −140° C.≤Tm, Tg<20° C.

3. The composition of matter of example 1, wherein the cross-linker compounds are each a 2-ureido-4[1H]-pyrimidinone of the structure

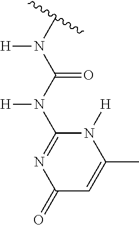 [SMILES: *NC(=O)Nc1nc(=O)cc(C)[nH]1]

4. The composition of matter of any of the examples 1-3, wherein one or more of the cross-linker compounds are terminated by the hydrogen bonding group comprising an oxygen, nitrogen, fluorine, sulfur or other moiety capable of attaching to a reversible hydrogen bonding moiety.

5. The composition of matter of any of the examples 1-4, wherein the side-chain comprises a poly(4-methylcaprolactone).

6. The composition of matter of any of the examples 1-5, wherein a molar fraction p of the side-chains that contain a cross linker end group in each of the bottlebrush polymers is 0.1≤p≤0.8, where p=number of moles of cross-linker compounds per unit weight of bottlebrush polymer divided by the total number of moles of the side-chains per unit weight of the bottlebrush polymer.

7. The composition of matter of any of the examples 1-6, wherein the monomer units before polymerization comprise a norbornene, a styrene, an acrylate, a (meth)acrylate, or an acrylamide.

8. The composition of matter of any of the examples, wherein the backbone has the structure:

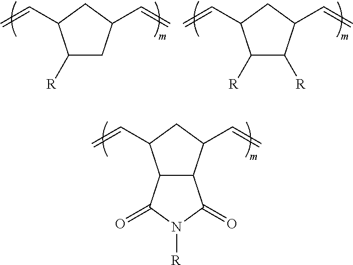

and m is an integer and R is a side-chain.

9. The composition of matter of any of the examples, wherein the backbone has the structure:

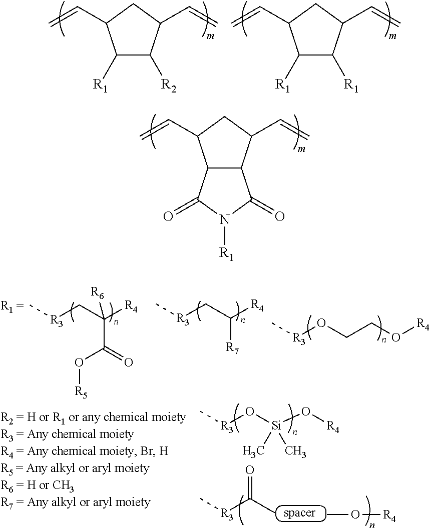

wherein R₄ can be any chemical moiety, Br, H or crosslinker; the spacer can be any alkyl or aryl moiety, including CH₂CH(R₅)CH₂CH₂CH₂, CH₂CH₂CH(CH₃)CH₂CH₂, CH₂CH₂CH(R₅)CH₂CH₂, CH₂CH₂C(R₅)₂CH₂CH₂, CH₂CH₂CH₂CH(R₅)CH₂, CH₂CH₂CH₂CH₂CH(R₅), CH₂CH(R₅)CH₂CH₂, CH₂CH₂CH₂CH(R₅) and CH₂CH₂CH(R₅)CH₂. and m, n are integers.

10. The composition of matter of any of the examples 1-9, wherein the side-chains comprise at least one of a polyester, an oligomeric ester, a polyether, an oligomeric ethylene oxide, a poly(ethylene oxide), an oligomeric propylene oxide, a poly(propylene oxide), an oligomeric propylene, polypropylene, an oligomeric isobutylene, a polyisobutylene, a poly(dimethylsiloxane), an oligomeric dimethylsiloxane, an oligomeric acrylate, polyacrylate, or a polystyrene.

11. The composition of matter of any of the examples 1-10, wherein the cross-linker compounds comprise at least one of a N-propylthymine, an aminopyridine, a diaminopyridine, an acetylpyridine, a diacetylaminopyridine, an aminopyrimidine, diamonopyrimidine, an acetylpyrimidinone, a diacetylpyrimidinone, an aminotriazine, a diaminotriazine, an ureidotriazine, an ureidopyrimidinone, a N-carbamoyl squaramide, a 2,7-bis(acylamino)-1,8-naphthyridine, a pyridylurea, a dipyridylurea, or a dipyrimidinylamine.

12. The composition of matter of any of the examples 1-11, wherein T_{g}, Tₘ, and an amount of the crosslinker compounds in the bottlebrush polymers are selected such that the bottlebrush polymers form an elastomer with a uniaxial tensile elastic modulus in a range of 100 Pa to 1 MPa at a temperature in a range of −20° C. to 50° C. or −20° C. to 40° C.

13. The composition of matter of any of the examples 1-12, further comprising:
an amount of the crosslinker compounds in the composition of matter selected or tuned such that the composition of matter has a shear modulus in a range of 100 Pa to 1 MPa as measured by a rheometer when strain rate is in a range of 1 s⁻¹ to 5 s⁻¹, the tensile strain is applied at a frequency in a range of 0.1 to 100 rad/s using a strain amplitude of 1%≤strain amplitude 5% in a temperature range of −40° C. to 100° C., or as measured by a texture analyzer.

14. An elastomer, actuator, adhesive, or pressure sensor comprising the composition of matter of any of the examples 1-13.

15. A method of making the composition of matter of any of the examples, comprising:
providing an amount of the cross-linker compounds in the bottlebrush polymers to obtain a desired elastic modulus of the composition of matter in range where the elastic modulus of the composition of matter is a linear function of the amount of cross linker compound.

16. The method of example 15, wherein:
the function is a straight line characterized by a first fitting parameter (a) and a second fitting parameter (b),
the first fitting parameter is proportional to the slope of the straight line and a y-intercept of the straight line is proportional to the second fitting parameter, and
the first fitting parameter and the second fitting parameter are extracted by fitting the measured elastic moduli with the function for various compositions of matter having different side-chain and backbone lengths and crosslinker loadings.

17. The composition of matter of any of the examples 1-14 having the structure:

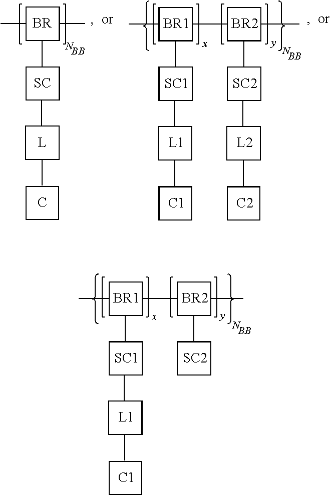

wherein:
BR, BR1, BR2 comprise the backbone monomer unit, BR1 and BR2 can be different or the same;
SC, SC1, SC2 comprise a linker side-chain moiety for linking the backbone to the linker compound, SC1 and SC2 can be different or the same;
L, L1, L2 comprise the linker compound, L1 and L2 can be different or the same; and
C, C1, C2 comprise the crosslinker compound, C1 and C2 can be different or the same.

18. The composition of matter of any of the examples 1-17, wherein the hydrogen bonds are such that the composition of matter reversibly transitions between an elastic solid and a viscoelastic liquid upon repeated heating and cooling cycles.

19. An adhesive comprising the composition of matter of example 18, wherein a degree of adhesion is tuned by the concentration of the hydrogen bonds.

20. The composition of matter of example 18 or 19, wherein the elastomer is self-healing between a temperature of 35° C. and a temperature below a decomposition temperature of the elastomer, and the self-healing is characterized by the elastomer reversibly transitioning between the elastic solid and the viscoelastic liquid upon repeated heating to the temperature of at least 35° C. and cooling to a temperature below 35° C.

21. The composition of matter of example 20, further comprising a composition of the hydrogen bonding groups and a concentration of the hydrogen bonding groups selected to obtain the self healing temperature.

22. An additive comprising the composition of matter of any of the examples 1-21.

23. In yet a further example, super-soft elastomers comprising bottlebrush polymers that have unique rheological properties due to hydrogen-bonding end groups. In one example, the bottlebrush polymer comprises hydrogen-bonded bottlebrush polymer made of poly-4-methyl caprolactone as the sidechain end-capped with strong hydrogen-bonding moiety: ureido-pyrimidinone (UPy). The dynamics of associative bottlebrush networks of this example were studied by performed thermal and rheological characterizations on a series of UPy-functionalized bottlebrush polymers with different lengths of sidechain and backbone and UPy molar amounts (p). This study showcases a remarkable range of tunable network modulus (27 kPa-1.6 MPa) while retaining the self-healing ability and re-processability near 100° C.

24. The composition of matter of any of the examples 1-23, wherein the network modulus is proportional top and well described by a classic associative network model using the molar mass of a macromonomer instead of a monomer, and wherein, optionally, a much weaker dependence of the glass transition temperature (T_{g}) on p than the literature-reported linear analogs suggests the dilution effect of sidechains; and the dissociation dynamics for the bottlebrushes are no longer expected to be coupled among nearby associative moieties or significantly delayed, as reported in other linear polymers; and further optionally wherein the UPy pair dissociation time remains unchanged even for our fully functionalized bottlebrush after normalizing the T_{g}, while the sticky Rouse region can stretch across over four decades in frequencies without any sign of reaching the terminal behavior.

### BRIEF DESCRIPTION OF THE DRAWINGS

Referring now to the drawings in which like reference numbers represent corresponding parts throughout:

FIG. 1(a). Schematic of h-bonded bottlebrush network and Polymerization schematic for generating hydrogen-bonded bottlebrush polymer networks.

FIG. 1(b). The macromonomer-first approach can be used to study sequence effects by controlling the density and location of H-bonding groups along the bottlebrush backbone.

FIG. 2. Impact of UPy molar fraction (p) on glass transition temperatures (T_{g}) of hydrogen-bonded bottlebrushes. (a) DSC traces for bottlebrush polymers with different UPy amounts and the same N_{SC} and N_{BB}. Data are vertically shifted for clarity. T_{g} is located by the midpoint method, as indicated by the star symbols. (b) Compare the dependence of increase in T_{g} relative to the neat polymer (ΔT_{g}) on p between the UPy-functionalized linear polymers in literature^{19,20} (squares and triangles) synthesized from PnBA precursors and our bottlebrush polymers (stars). (c) The relative increase in T_{g} varies with the weight fraction of UPy. The star symbols represent our work on UPy-functionalized pMCL bottlebrushes. The square and triangle symbols represent literature results of UPy-functionalized linear PnBA polymers. Error bars were estimated based on the small uncertainty associated with the midpoint method of quantifying T_{g}. (d) DSC traces for UPy-functionalized bottlebrush polymers with longer N_{BB} and N_{SC}, respectively. T_{g} was located by the midpoint method as marked by star symbols.

FIG. 3 (a) Master curves based on superimposing low-frequency G′ data (left panel) and high-frequency G″ data (right panel) for hydrogen-bonded bottlebrushes with different UPy amounts and backbone/side-chain lengths. T_{ref}=−20° C.

FIG. 3(b) Temperature dependence of shift factors, a_{T} and a_{T}′, generated from constructing the master curves in FIG. 3(a). The solid line represents the WLF fit for neat pMCL bottlebrush (data shown in FIG. 4(h)). T_{ref}=−20° C. (c) Natural logarithm of a ratio shift factors, a_{T}/a_{T}′, for all the hydrogen-bonded bottlebrushes in (b) against the inverse of absolute temperature 1/T. The solid line represents the linear fit with a slope of Eₐ/k, where Eₐ is the activation energy for UPy dissociation. Only the data between 12.5 and 50° C. were fit because of the poor overlap in the master curves for G″ at elevated temperatures (70, 100° C.) and high frequencies (see FIG. 3(a)). Consequently, in FIG. 3(c), we limited the temperature window between 12.5 and 50° C., where both Rouse and sticker dynamics are active.

FIG. 3(d)-(e). Bottlebrush architectural effect on the linear viscoelastic behavior of hydrogen-bonded networks via changes in the length of (d) backbone and (e) sidechain. All master curves were generated by applying the horizontal shift factor a_{T} to superimpose the low-frequency region of G′ data with respect to a reference temperature of −20° C. I: Terminal relaxation, II: Stick-Rouse Relaxation; III: Hydrogen bonded bottlebrush network plateau; IV: Rouse relaxation of bottlebrush segments and transition to plateau; V: Rouse relaxation of sidechain; VI: Glass transition region.

FIGS. 4(a)-(d). Complex moduli for pMCL bottlebrushes with different molar fractions of UPy moieties p at a reference temperature of (a) −20° C. and (c) the isofrictional temperature T_{g}+35° C., at which tan δ is also plotted in (d). Both the target degree of backbone polymerization (N_{BB}=300) and the degree of sidechain polymerization (N_{SC}=17) are fixed. Horizontal shift factors (a_{T}) were generated by superimposing the low-frequency region of G′ data. (b) Correlation between plateau modulus (Gx) and p for both UPy-PnBA linear polymer (open symbol) and our UPy-pMCL bottlebrush polymer (solid symbol). Black lines represent the best-fitted linear lines.

FIG. 4(e)-(f). Impact of bottlebrush architectural parameters on the linear viscoelastic behavior of hydrogen-bonded networks. (e) Varying N_{BB} at constant N_{SC}=17 and p=0.05. (f) Varying N_{SC} while holding N_{BB}=300 and the network strand volume constant. All master curves were generated by applying a horizontal shift factor a_{T} to superimpose low-frequency G′ data for a given dataset with respect to a reference temperature of −20° C.

FIG. 4(g)-(k). Complete set of master curves for all UPy-functionalized pMCL bottlebrushes with different UPy mole fractions (p) and the same side-chain and backbone length (i.e., N_{SC}=17, N_{BB}≈300) at the reference temperature of (g) −20° C. with (h) corresponding horizontal shift factors. Master curves shifted to the isofrictional reference temperature of (i) T_{g}+35° C. with the corresponding (j) horizontal shift factors and (k) tan δ.

FIG. 5. (a) Thermal reversibility check via a temperature ramp test for hydrogen-bonded pMCL bottlebrushes with different UPy molar fractions (p), namely pNb⁶⁰⁰-pMCL¹⁷-UPy⁶ and pNb³⁰⁰-pMCL¹⁷-UPy²⁵, undergo softening at ca. 40° C. Same heating and cooling rate at 5° C./min and a constant oscillatory frequency at 1.0 rad/s. (b) Photos capture different stages of self-healing demonstration for pNb⁶⁰⁰-pMCL¹⁷-UPy⁶. The sample was first cut and rejoined at room temperature and then heated in rheometer to 35° C. for 5 mins. After cooling to room temperature, the sample was stretched to visualize the healed joint. Uniaxial tensile tests at room temperature for pristine and reprocessed (c) pNb³⁰⁰-pMCL¹⁷-UPy²⁵ and (d) pNb³⁰⁰-pMCL¹⁷-UPy⁵ demonstrate the self-healed mechanical properties of hydrogen-bonded pMCL bottlebrush networks. Both samples were reprocessed at 100° C. after rupture. FIG. 5 shows similar healing dynamics and demo for two samples with drastically different moduli.

FIG. 5(e)-(h). Rheometry of pMCL bottlebrushes with different mole fractions of UPy (p). (e) At a reference temperature (T_{ref}) of −20° C. (f) Correlation between the plateau modulus (Gₓ) and p for UPy-PnBA linear polymers from Feldman et al. (open symbols) and UPy-pMCL bottlebrush polymers (solid symbols). Black lines represent best linear fits. (g) Referenced to the isofrictional temperature T_{ref}=T_{g}+35° C.; tan δ is also plotted in (h). In these datasets, N_{BB}=300 and N_{SC}=17 are fixed. Horizontal shift factors (a_{T}) were generated by superimposing low-frequency G′ data.

FIG. 5 (i) Stress-relaxation data for a fully UPy-functionalized bottlebrush polymer (pNb³⁰⁰-pMCL¹⁷-UPy¹⁰⁰) at 100° C. and a step strain of 1%. The sticky Rouse region with a characteristic slope of −½ stretches more than four decades from 10⁻¹ to 10³ s.

FIG. 5(j) Extended master curve in FIG. 4a with the Fourier-transformed frequency sweep data from (i) at a reference temperature of −20° C.

FIG. 5(k) Rod of pNb³⁰⁰-pMCL¹⁷-UPy⁵ formed using a rheometer.

FIG. 5(l). Snapshots of the tensile testing process performed automatically by rheometer.

FIG. 5(m). Processing and reprocessing steps to obtain samples for tensile testing on pNb³⁰⁰-pMCL¹⁷-UPy²⁵.

FIG. 5(n). Raw data for uniaxial tensile tests of pNb³⁰⁰-pMCL¹⁷-UPy²⁵ before and after reprocessing.

FIG. 5(o) Magnification of 5(n) to illustrate that the background signal originates from initial acceleration of the moving head.

FIG. 5(p) Force-distance was converted to stress-stain by subtracting the background; uniaxial tensile data for pNb³⁰⁰-pMCL¹⁷-UPy²⁵ is plotted in FIG. 5c.

FIG. 6. Stacked ¹H NMR of (top) Nb-pMCL¹⁷ (CDCl₃) and (bottom) Nb-pMCL¹⁷-UPy (CDCl₃) showing complete disappearance of the terminal pMCL methylene (H_{A}) after functionalization, which suggests complete functionalization as confirmed by the appearance of H_{B} and H_{C}.

FIG. 7. ¹H DOSY of Nb-pMCL¹⁷-UPy in acetone-d₆ shows a single population at an approximate diffusion coefficient of 2×10⁻¹⁰ m²/sec in the presence of residue acetone and water.

FIG. 8. MALDI MS spectra of Nb-pMCL¹⁷-UPy. (a) Full spectrum. (b) Magnified spectrum showing separation of 128.0 m/z.

FIG. 9. The effect of hydrogen bond strength by using Napy to displace UPy in H-bonding bottlebrush materials.

FIG. 10. Flowchart illustrating a method of synthesizing a composition of matter according to one or more embodiments.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

The present disclosure reports on compositions of matter having elastomeric properties and comprising a plurality of bottlebrush polymers. Each of the bottlebrush polymers comprise a backbone including a plurality of monomer units and a plurality of side-chains attached to the backbone at the monomer units. One or more of the side-chains each comprise a linker compound terminated with a cross-linker compound. The composition of matter further comprises a plurality of hydrogen bonds forming reversible bonds between the cross-linker compounds in different ones of the bottlebrush polymers, so as to form cross-links between different ones of the bottlebrush polymers. A concentration of the hydrogen bonds can be tuned and the one or more of the side-chains each have at least one of a glass transition temperature T_{g} or a melting temperature Tₘ below minus twenty degrees Celsius so that the composition of matter is amorphous and/or comprises an elastomer having at least one of a modulus less than 1 MPa at a temperature 23° C. or a melting temperature Tₘ less than 30° C., or less than 29° C.

One or more of the side-chains can each have a glass transition temperature T_{g} and a melting temperature Tₘ below minus twenty degrees Celsius so that the composition of matter is amorphous and/or comprises an elastomer at a temperature T above −20° C. or such that −20° C.≤T≤30° C.

The bottlebrush polymers can be embodied in many ways. Illustrative embodiments are described in the following examples (referring also to supplementary figures denoted with prefix S and found in Appendix B of the priority application).

### Example Network Design and Synthesis

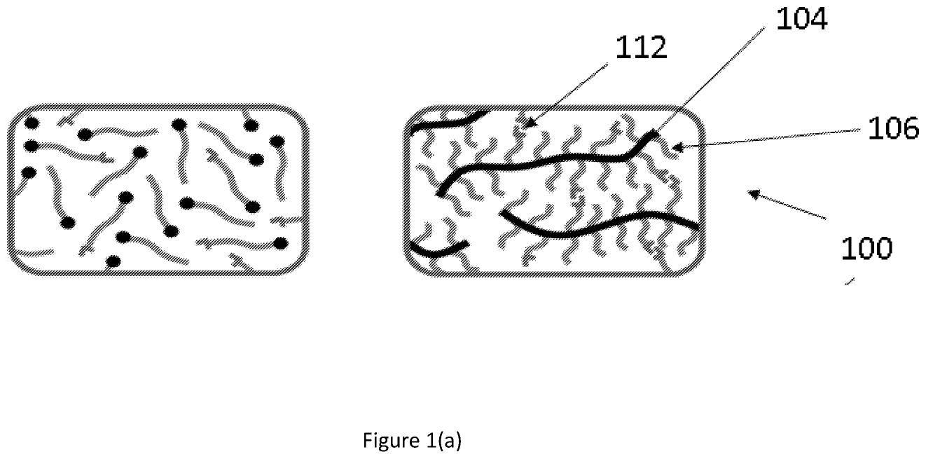

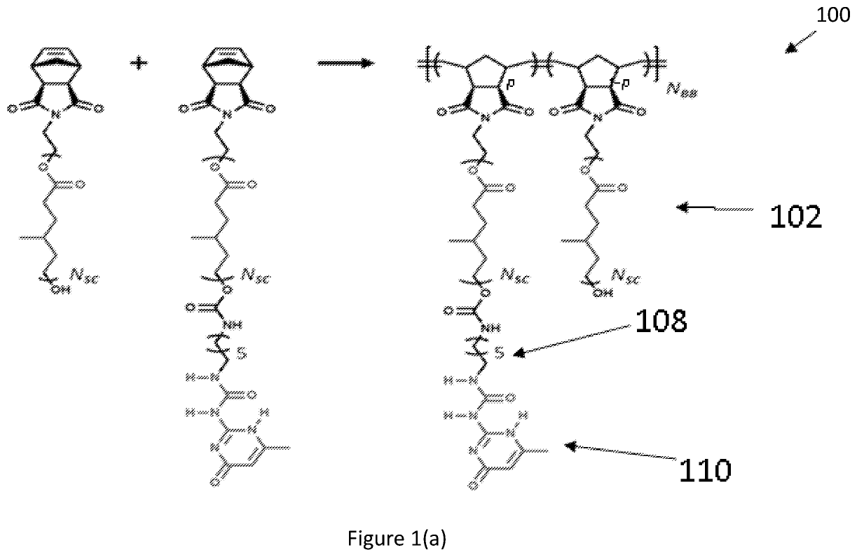

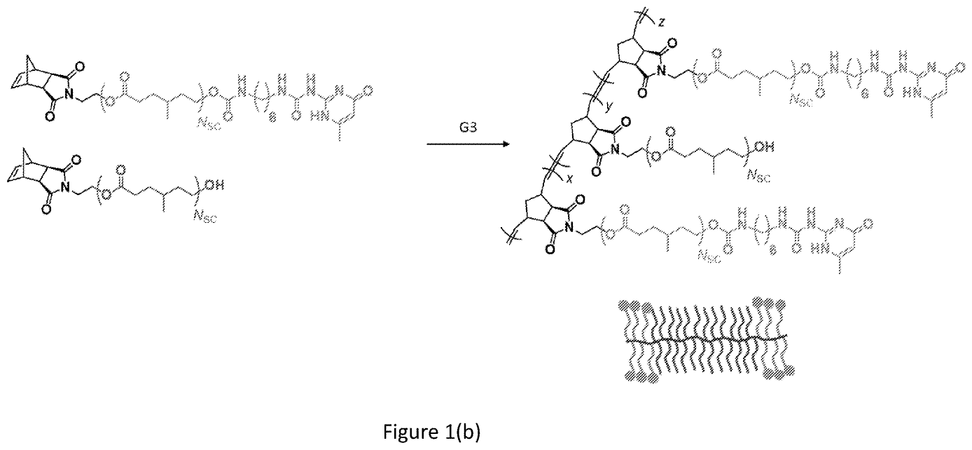

We designed a hydrogen-bonding bottlebrush polymer with a polyester sidechain end-capped with ureido-pyrimidinone (UPy) moiety as the model system for the physically associative bottlebrush network. The UPy, one of the strongest hydrogen bonding moieties, is covalently attached to the end of the sidechain and forms an associative complementary pair with another nearby UPy unit via quadruple hydrogen bonding, leading to a robust hydrogen-bonded bottlebrush network. We selected poly(4-methylcaprolactone) (pMCL) as the sidechain chemistry due to its low glass transition temperature (T_{g}≈−60° C.), biocompatibility, and synthetic accessibility. Macromonomers of pMCL were synthesized according to the previously published method¹⁸ and characterized by ¹H NMR to determine the sidechain degrees of polymerization (N_{SC}). Two batches of pMCL macromonomers with different N_{SC}s (i.e., 17 and 34) were prepared, and each batch was then divided into two portions. Only one portion was fully functionalized by reacting their hydroxyl end group with ureido-pyrimidinone isocyanate, as verified by ¹H NMR (FIG. 6). Finally, we prepared the statistical bottlebrush copolymers by polymerizing a mixture of the fully functionalized macromonomers and neat macromonomers at selected ratios via ring-opening metathesis polymerization (ROMP), as depicted in FIG. 1. This macromonomer-first approach of forming hydrogen-bonded bottlebrush polymers provides precise control on the UPy amount than the post-functionalization of neat bottlebrush polymers. Multiple gram-scale hydrogen-bonded bottlebrush polymers from the same batch of pMCL macromonomer with N_{SC} of 17 were prepared with different molar fractions of UPy modified sidechains (p) while maintaining a constant average backbone degree of polymerization N_{BB} of 300. In the following analysis, p represents the mole fraction of backbone repeat units functionalized with a single UPy, i.e., for bottlebrushes, at one side-chain end: pMCL-UPy/(pMCL-OH+pMCL-UPy). (The interpretation of p will be the same for linear materials used as a comparison, however, in this case, because there are no side chains, it is equivalently the mole fraction of monomers functionalized with UPy.) Two additional samples were synthesized using the same statistical polymerization approach with a much longer targeted backbone (N_{BB}=600) and sidechain (N_{SC}=34). Molecular characterizations of all bottlebrush polymers studied herein are summarized in Table 1 below.

TABLE 1
Molecular characterizations of bottlebrush polymers

| | N_{SC} | Target | Mₙ | | Target | Actual | T_{g} |
|---|---|---|---|---|---|---|---|
| Bottlebrush ID | * | N_{BB} | (kDa) \hat{ } | Ð | p | p ^{#} | (° C.) |
| Nb-pMCL¹⁷ | 17 | — | 3.2 | 1.18 | — | — | −62.0 |
| Nb-pMCL³⁴ | 34 | — | 6.4 | 1.12 | — | — | −61.3 |
| pNb³⁰⁰-pMCL¹⁷ | 17 | 300 | 125 | 1.54 | — | — | −57.7 |
| pNb³⁰⁰-pMCL¹⁷- | 17 | 300 | 60 | 1.60 | 0.064 | 0.05 | −57.5 |
| UPy⁵ | | | | | | | |
| pNb³⁰⁰-pMCL¹⁷- | 17 | 300 | 106 | 1.77 | 0.12 | 0.11 | −55.5 |
| UPy¹¹ | | | | | | | |
| pNb³⁰⁰-pMCL¹⁷- | 17 | 300 | 118 | 1.69 | 0.25 | 0.25 | −54.0 |
| UPy25 | | | | | | | |
| pNb³⁰⁰-pMCL¹⁷- | 17 | 300 | 128 | 1.69 | 0.36 | 0.33 | −52.3 |
| UPv33 | | | | | | | |
| pNb³⁰⁰-pMCL¹⁷- | 17 | 300 | — | — | 0.75 | — | −47.5 |
| UPy⁷⁵ | | | | | | | |
| pNb³⁰⁰-pMCL¹⁷- | 17 | 300 | — | — | 1 | — | −45.9 |
| UPy¹⁰⁰ | | | | | | | |
| pNb⁶⁰⁰-pMCL¹⁷- | 17 | 600 | 211 | 1.71 | 0.065 | 0.06 | −56.7 |
| UPy⁶ | | | | | | | |
| pNb³⁰⁰-pMCL³⁴- | 34 | 300 | 114 | 1.47 | 0.1 | 0.08 | −58.2 |
| UPy⁸ | | | | | | | |

* Determined by ¹H-NMR
\hat{ } Number-average molecular weight determined relative to the polystyrene standards
^{#} Determined by ¹H-NMR

On the other hand, pNb-pMCL-UPy bottlebrush copolymers were also synthesized by post-functionalization of p-Nb-pMCL bottlebrush polymers with ureido-pyrimidinone (UPy) (bottlebrush-first). With this approach, a single batch of polymer can be functionalized to different extents. However, we found that it was more challenging to keep the molar fraction of UPy functionalization precise when installing UPy after the bottlebrush synthesis.

The macromonomer-first approach also allows us to study the effect of side-chain sequence by synthesizing statistical and block bottlebrushes with controlled placement of the H-bonding groups and OH chain ends. FIG. 1b illustrates the example of an ABA triblock copolymer that can be synthesized via sequential ROMP polymerization, where both A and B are pMCL but with A blocks having H-bonding chain ends while B is terminated with a hydroxyl group. We anticipate that these types of blocky bottlebrush copolymers can mimic physically-crosslinked systems but with hard domains composed of UPy instead of glassy end blocks.

### Thermal Properties of the First Example

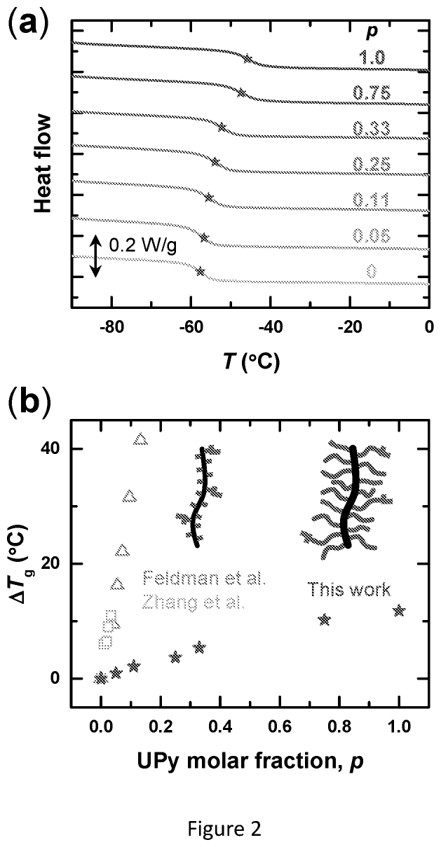

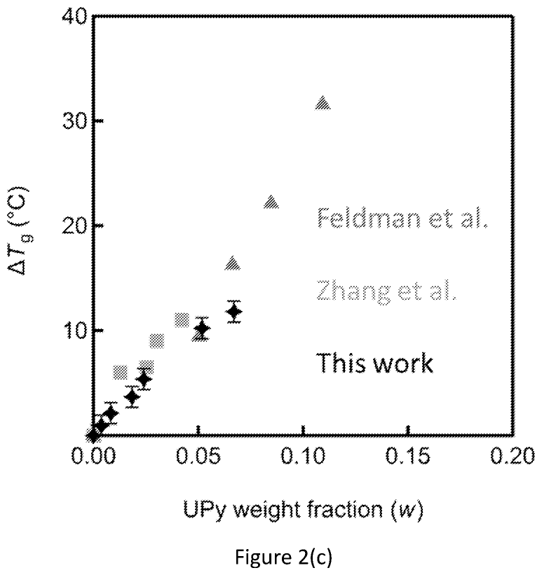

FIG. 2a illustrates examination of the thermal properties of hydrogen-bonded bottlebrush polymer networks by differential scanning calorimetry. As the pMCL-based bottlebrush polymer evolves from neat (i.e., no UPy, p=0) to a fully functionalized case (i.e., every sidechain end is attached with UPy moiety, p=1), the glass transition temperature (T_{g}) increases from −57.7 to −45.9° C., as summarized in Table 1. This trend is expected because incorporating more chain ends in forming associative UPy pairs provides additional friction that restricts chain diffusion, thereby reducing the free volume and increasing the T_{g}. More interestingly, FIG. 2b shows that this elevation in T_{g} relative to the neat polymer (ΔT_{g}=T_{g}−T_{g, neat}) is much weaker than that of the linear analog^{19,20}, for which p is defined as the molar fraction of UPy-functionalized monomer instead of macromonomer. Despite their differences in chemistry, pMCL versus poly(n-butyl acrylate) (PnBA)^{19,20}, we attribute this weaker T_{g} dependence in bottlebrushes to the dilution effect of the sidechains. The UPy pair association only constrains the sidechain end motion, but the segmental movement for the rest of the sidechain and backbone remains mostly unperturbed. Such a molecular picture contrasts starkly with the UPy-functionalized linear polymer, where its segmental motion becomes heavily restricted along the chain at multiple locations. FIG. 2c, ΔT_{g} versus weight fraction of UPy moiety, shows a decent collapse of data for both bottlebrush and linear polymers, verifying that the dilution effect is the leading cause of the weaker T_{g} dependence on p for bottlebrushes in FIG. 2b.

The T_{g} for two hydrogen-bonded bottlebrushes with longer sidechain and backbone lengths are comparable to a polymer with a similar number of Upy groups. Specifically, the longer N_{BB} sample, pNb⁶⁰⁰-pMCL¹⁷-UPy⁶, has a T_{g} that is only 1° C. different from pNb³⁰⁰-pMCL¹⁷-UPy⁵ (Table 1). The T_{g} for pNb³⁰⁰-pMCL³⁴-UPy⁸ is less than 1° C. different than pNb³⁰⁰-pMCL¹⁷-UPy⁵ despite the longer N_{SC}. These data show that the number of Upy groups helps to set the T_{g}.

### Architectural Effect on Network Dynamics

Besides T_{g}, bottlebrush architecture could potentially alter the dynamics of the hydrogen-bonded network due to the lack of backbone entanglements and the diluted influence of UPy pair association on the chain diffusion. We investigated if the bottlebrush architecture changes the strength of the UPy pair association. Specifically, we extracted the activation energies to dissociate the UPy pair (Eₐ) for our bottlebrush polymers based on the temperature dependence of relaxation times (i.e., horizontal shift factor a_{T} in generating master curves) and then compared them with the literature values for linear polymers.

However, because the UPy pair dissociation time (or “sticker” lifetime τₛ) exhibits a different temperature dependence than that of the characteristic time of a Kuhn segment τ₀, the time-temperature superposition fails substantially at temperatures where both Rouse motion and sticker dissociation are active. Therefore, we adopted an established method²⁰ for linear associative polymers to differentiate the temperature dependences of these two relaxation times. The sticker dissociation dominates the viscoelastic behavior at the low-frequency region, so horizontally shifting the isothermal frequency sweep data to superimpose the low ω G′ data should generate a_{T}, which represents the temperature dependence of sticker dissociation. Likewise, reshifting the data horizontally to superimpose the high ω G″ data should generate a_{T}′, representing the temperature dependence of Rouse motion.

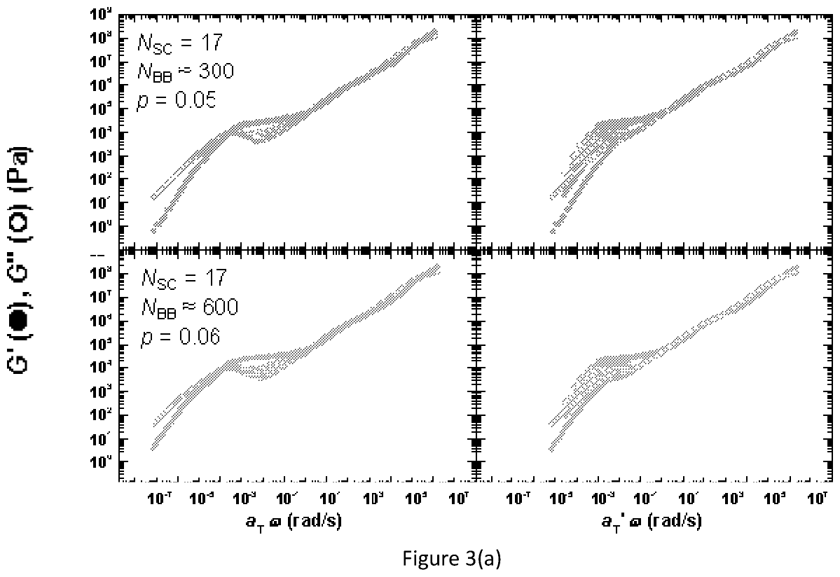

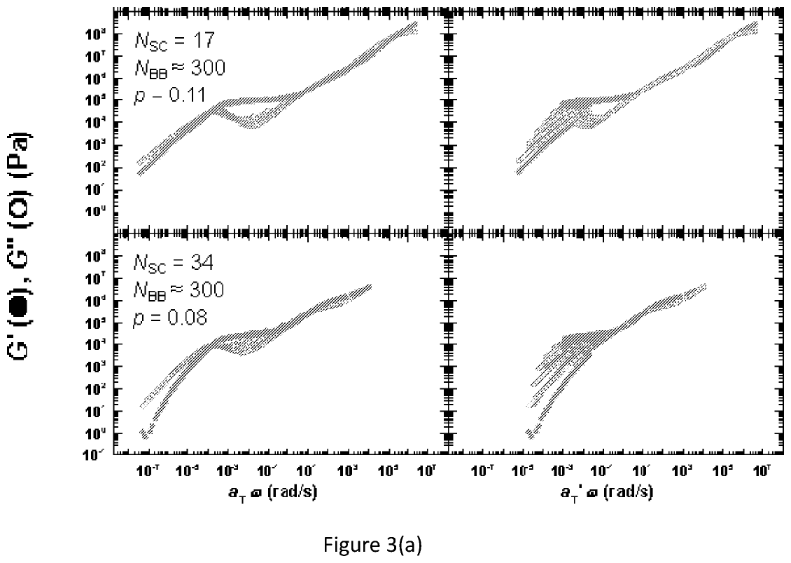

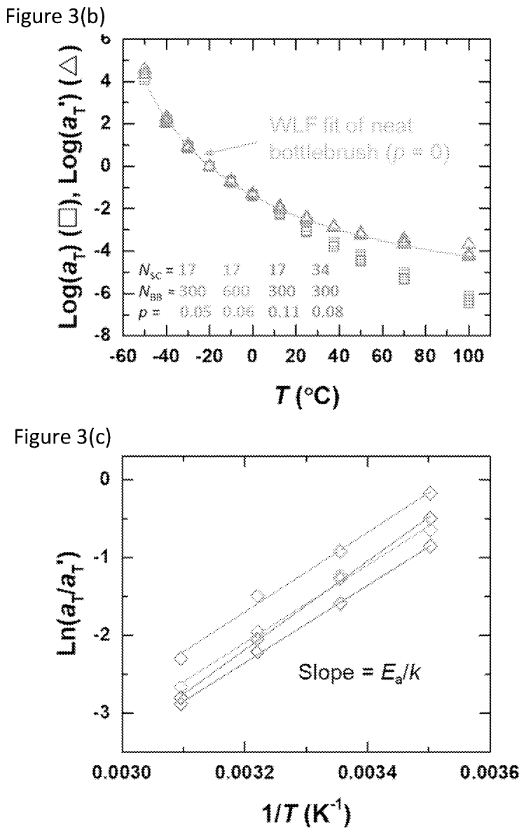

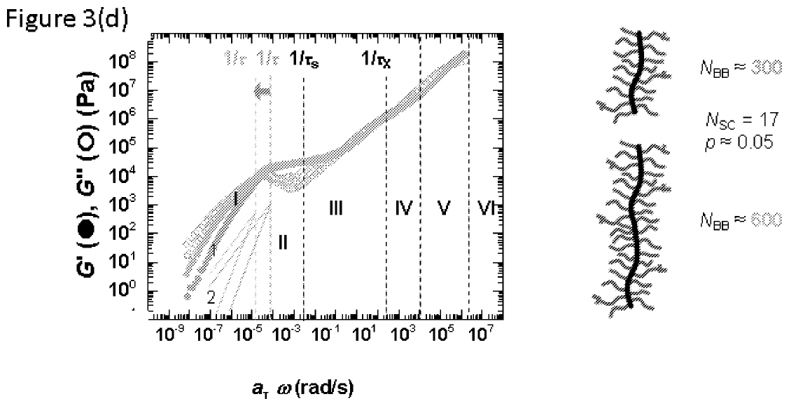

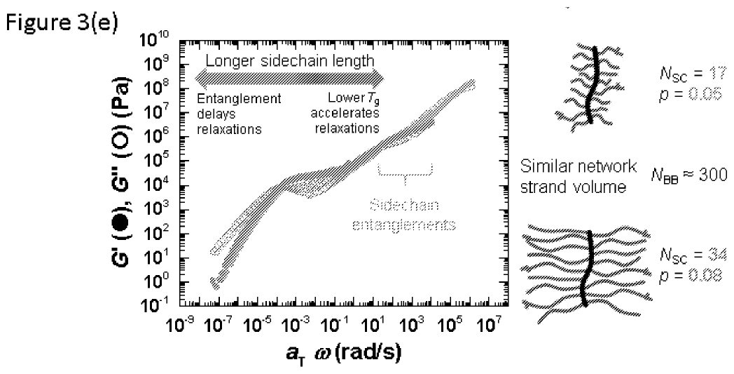

The resulting master curves from these two data-shifting methods for bottlebrush polymers with different p, N_{SC}, and N_{BB} are summarized in FIG. 3a. In FIG. 3b, it becomes apparent that the Rouse motion is indeed responsible for the observed temperature dependence of a_{T}′, which nicely follows the Williams-Landel-Ferry (WLF) fit of the neat pMCL bottlebrush polymer with pure Rouse dynamics. The deviation between a_{T} and a_{T}′ starts between 0 and 12.5° C., above which the sticker dissociation dynamics becomes active. Finally, because the ratio of sticker lifetime and Kuhn monomer relaxation time, τₛ/τ₀, is proportional to a_{T}/a_{T}′, the activation energy Eₐ is then calculated by modeling the Arrhenius-type temperature dependence of a_{T}/a_{T}′, as depicted in FIG. 3c. Irrespective of backbone and sidechain lengths, we found similar Eₐs for bottlebrushes with the same UPy weight fraction (42±2 kJ/mol for pNb³⁰⁰-pMCL¹⁷-UPy⁵, 41±3 kJ/mol for pNb⁶⁰⁰-pMCL¹⁷-UPy⁶, 41±1 kJ/mol for pNb³⁰⁰-pMCL³⁴-UPy¹), which are close to that of the linear UPy-functionalized PnBA (33-37 kJ/mol)²⁰. Only the sample with a higher UPy weight fraction, namely pNb³⁰⁰-pMCL¹⁷-UPy¹¹, shows modestly higher activation energy of 47±1 kJ/mol. Overall, these results confirm that placing the UPy unit on the end of the sidechain increases the UPy pair's binding strength only slightly.

Albeit the mild influence on the UPy pair strength, the bottlebrush architecture is expected to play a more critical role in manipulating the viscoelasticity of hydrogen-bonded networks.

FIG. 3d-e captures how longer N_{BB} or N_{SC} alters the relaxation times at different length scales. Isothermal frequency sweeps were first collected from high temperature (100° C.) to low temperature (−40 or −50° C.) and then horizontally shifted to generate master curves at a reference temperature of −20° C. by superimposing the low-frequency G′ data with the corresponding horizontal shift factors (a_{T}) shown in FIG. 3b-c. As illustrated in FIG. 3d, at high frequencies, the hydrogen-bonded bottlebrush displays similar relaxation regions as a covalently linked bottlebrush network²¹: VI, glass transition; V, Rouse relaxation of sidechain; IV, Rouse relaxation of bottlebrush network strand (τₓ) and transition to plateau. However, this plateau in region III originates from the hydrogen-bonded bottlebrush network rather than a permanent network formed by covalent links. So, beyond the dissociation time of a hydrogen-bonded pair (or the lifetime of a sticker τₛ), stress relaxes through the repeated breakup-association processes of the hydrogen bonds (i.e., “sticky Rouse” region (II) with a slope of ½)²², followed by the transition to the terminal relaxation (I) at low frequencies. Both τₓ and τₛ are identified as the inverse of G′ and G″ crossover frequencies that define the plateau boundary. The terminal relaxation time τ is determined by extrapolating the terminal slopes of G′ and G″ to the intersecting frequency. Then, by comparing two hydrogen-bonded bottlebrushes with different backbone lengths but the same UPy molar fraction and sidechain length, the master curves show nearly identical plateau, Rouse relaxations of sidechain and bottlebrush segment, and glass transition regions irrespective of backbone degrees of polymerization N_{BB}. Longer N_{BB} only appears to extend the sticky Rouse region and delay the terminal relaxation time τ as long as the sticker concentration is well above the percolation threshold. Specifically, in FIG. 3d, the τ shows an estimated increase by a factor of 5, which corroborates the expected delay by a factor of 4 based on the scaling relation for Rouse dynamics (τ~N_{BB}²), testifying the excellent synthetic control on the backbone length and UPy functionalization.

FIG. 3e compares the master curves of UPy-functionalized bottlebrushes with different sidechain lengths (N_{SC}=17 and 34) but the same expected network strand volume at a reference temperature of −20° C. As depicted in the schematic next to FIG. 3e, by nearly doubling the UPy molar fraction, the network strand volume for the sample with a twice large N_{SC} should be, in theory, kept roughly the same as that with a shorter sidechain and lower UPy amount. Indeed, both samples' network moduli nearly coincide in the intermediate frequency region between 10⁻⁴ and 1 rad/s, proving the excellent synthetic control on the N_{SC} and UPy functionalization and no significant influence of N_{SC} on the effectiveness of UPy pair forming interchain crosslinking. As N_{SC} doubles from 17 to 34, which is larger than the entanglement length of linear pMCL (2.9 kDa or N_{SC, e}=21), the entangled sidechains response emerges as a high-frequency rubbery plateau on the order of 1 MPa. Although the number of entanglements is only about 1.6 (i.e., N_{SC}/N_{SC, e}), this plateau region stretches over two decades in frequencies due to the extremely slow relaxation via sidechain retraction.^{23,24} Thus, all the subsequent relaxations, including τₓ, τₛ, and τ, are delayed significantly. However, these delays in relaxation times are partially counteracted by a lower T_{g}, which accelerates relaxations, including the sidechain disentanglement.

### Network Characteristics of the First Example

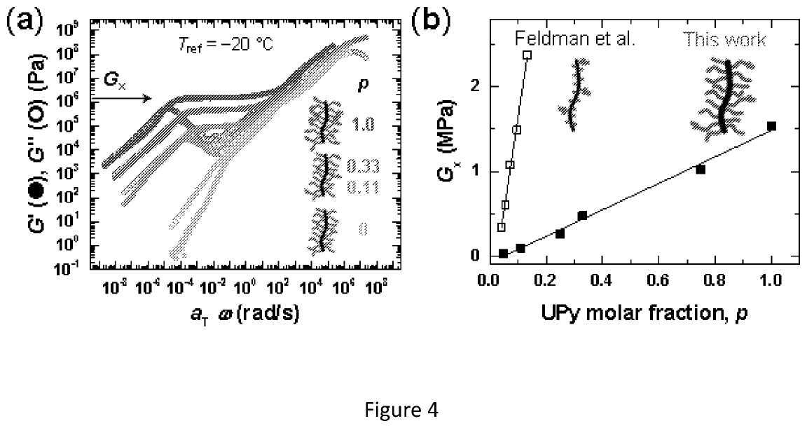

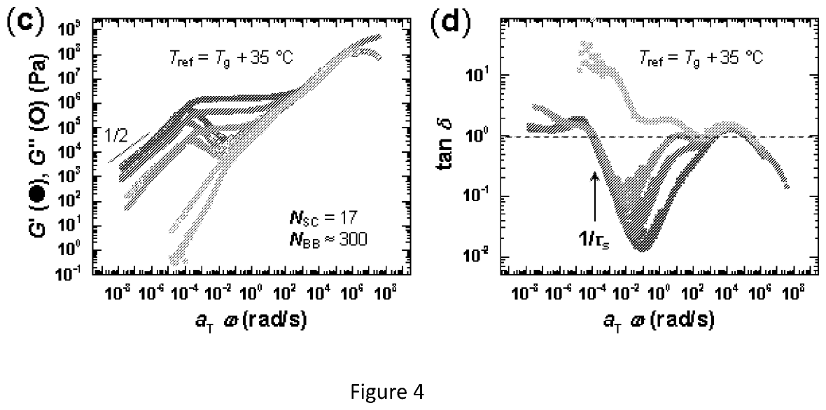

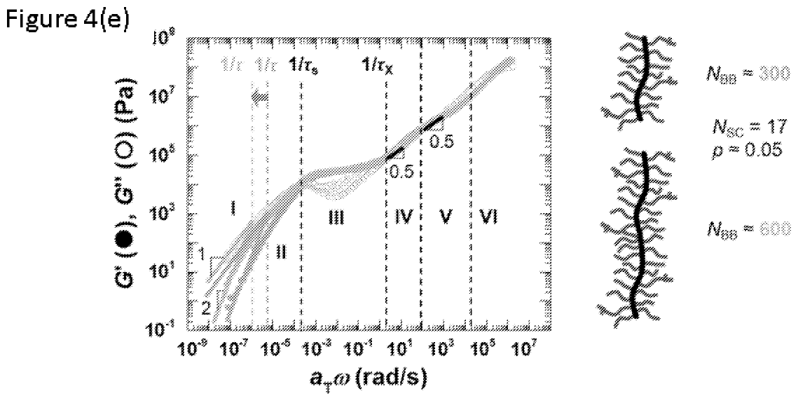

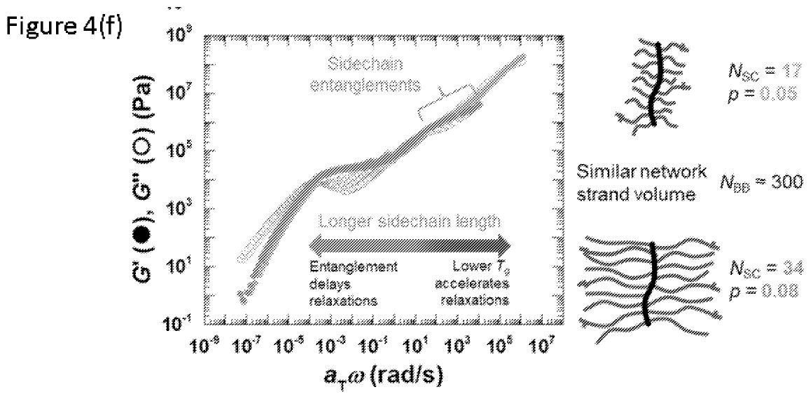

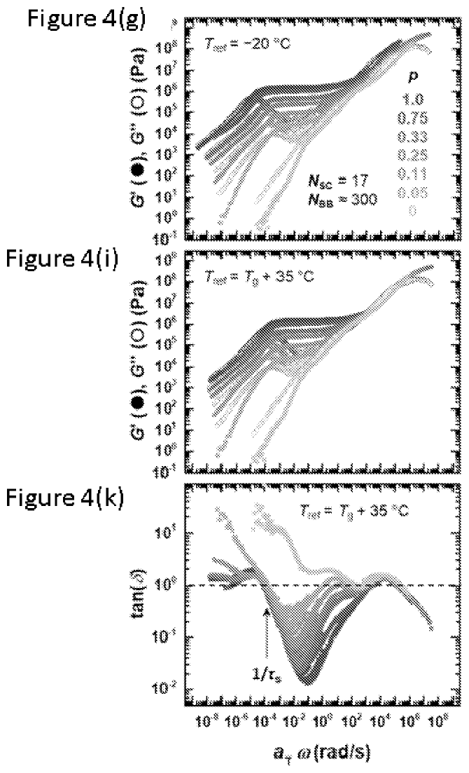

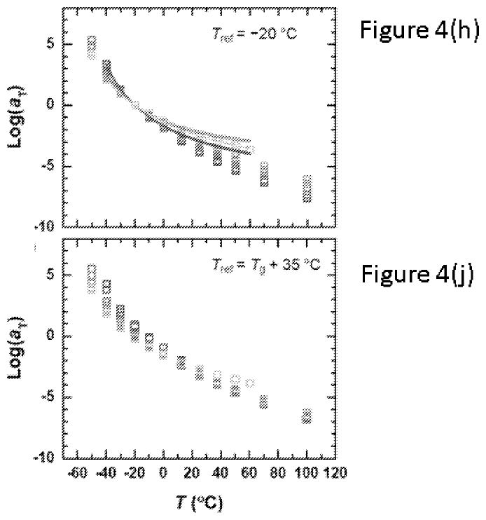

Besides the architectural effect on the hydrogen-bonded network dynamics, the molar fraction of UPy moiety (p) also dictates the network characteristics, including the network modulus and relaxations beyond the sticker lifetime. FIG. 4a shows the master curves for a series of representative pMCL bottlebrushes with p ranging from 0 (neat) to 1.0 (every sidechain end is attached with UPy moiety) and a constant N_{SC} and N_{BB} at a reference temperature of −20° C. Please see FIG. 4g-j for the complete set of master curves and corresponding shift factors. The scope of this work focuses on the hydrogen-bonded bottlebrush network with UPy molar fraction, p (0.05-1.0), well above the gel point, p_{c}=1/(N_{BB}−1)=0.0033. So, as p increases, the average bottlebrush network strand length decreases, leading to a shorter network strand relaxation time, τₓ, thus wider network plateau region, and higher network modulus Gₓ, which is determined as G′ at the local minimum of G″. We found that this remarkable range of Gₓ between 27 kPa and 1.6 MPa scales linearly with p and can be well described by a modified associative network model below,

$${G}_{x} = a ( \frac{p}{{p}_{c}} - 1 ) \frac{ρ {N}_{A}}{{M}_{n}} kTS \approx a ( p - {p}_{c} ) \frac{ρ {N}_{A}}{{M}_{S C}} k T \qquad ( 1 )$$

where a is a proportionality constant that combines contributions from crosslink functionality and fraction of intermolecular UPy pairs, p_{c} is the minimal molar fraction of UPy moiety that forms a critical gel, N_{A} is the Avogadro's number, k is the Boltzman constant, T is the absolute temperature, and ρ and Mₙ is the mass density and number-average molecular weight of polymer, respectively. In the context of a bottlebrush polymer network,

$${p}_{c} = \frac{1}{{N}_{B B} - 1} , {M}_{n} = {M}_{S C} {N}_{B B} , and S = \frac{〈 {R}_{i n}^{2} 〉}{{N}_{s , k} {b}_{k}^{2}} ,$$

which represents the potential entropy reduction factor²⁵ that originates from a more rod-like bottlebrush network strand as its average length decreases with increasing UPy amount and approaches the effective backbone Kuhn length. However, as depicted in FIG. 4b, the excellent linear fit of Gₓ and p proves that the S factor is essentially ineffective in modifying the network characteristics (i.e., S=1), agreeing with our finding on the photo-crosslinked bottlebrush networks with poly(norbornene) backbone²⁶. Additionally, the slope ratio of the linear PnBA over the pMCL bottlebrush matches the known molar mass ratio between a pMCL macromonomer and PnBA monomer (2.20×10⁷/1.56×10⁶≈N_{SC}=14 by MALDI MS)), suggesting a similar sidechain dilution effect on network moduli as that on T_{g} in FIG. 2.

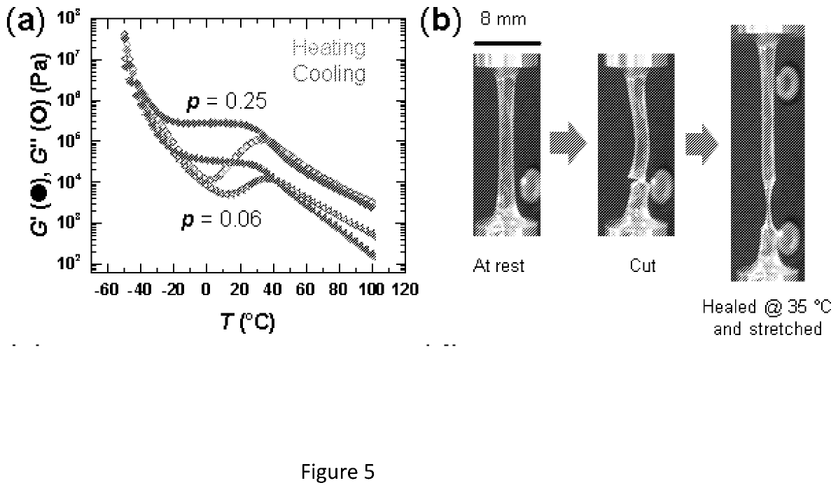

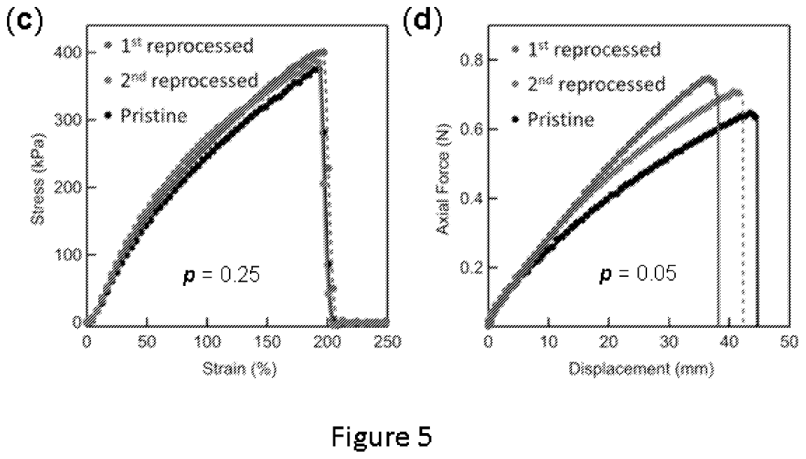

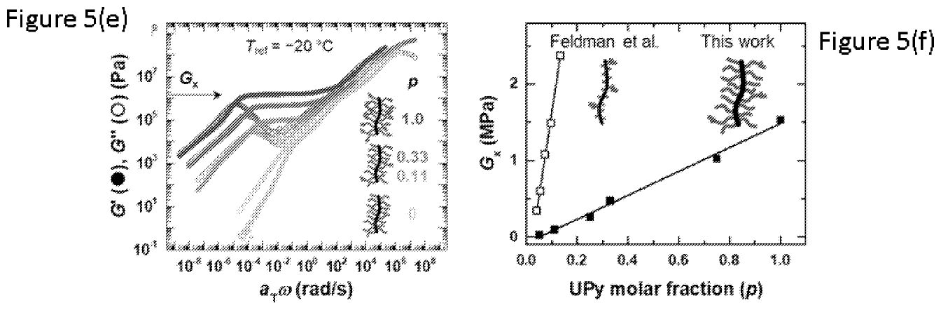

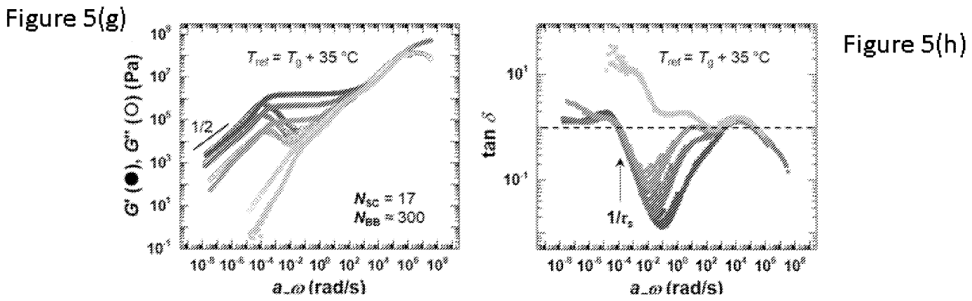

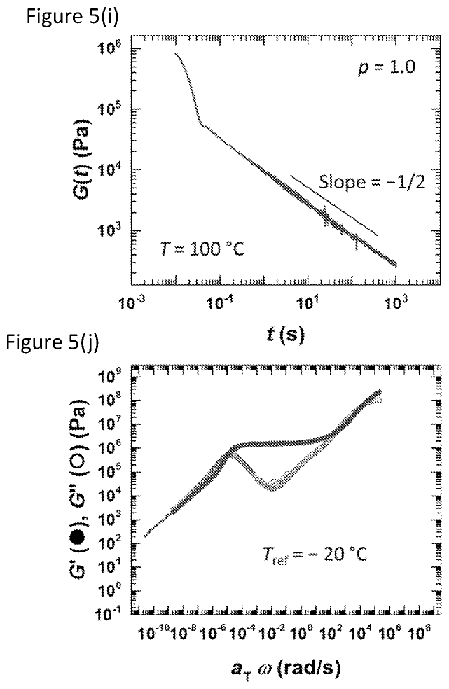

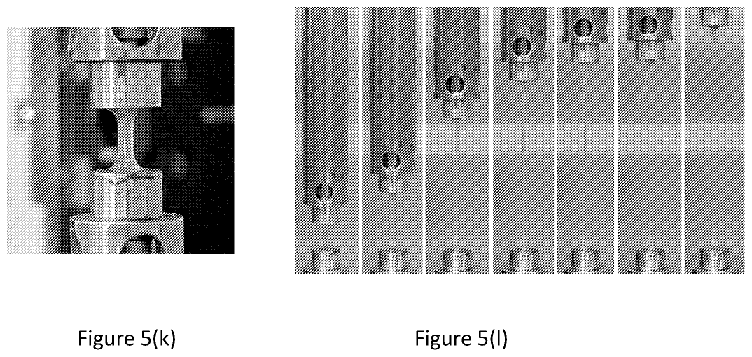

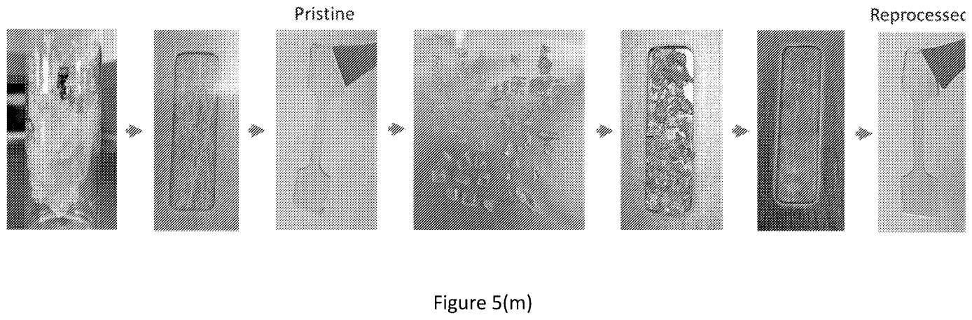

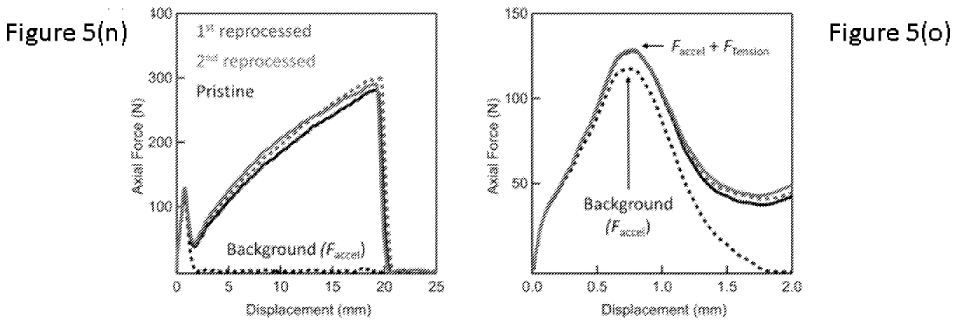

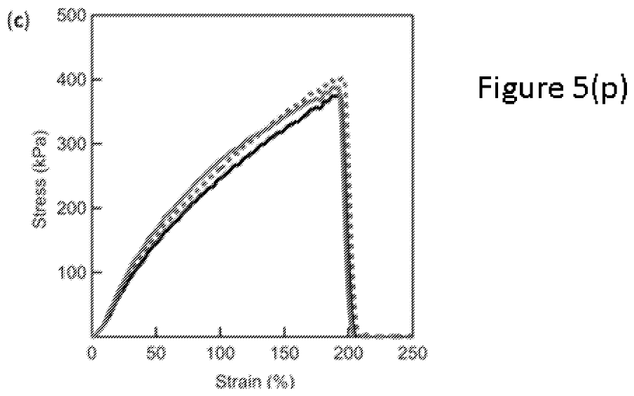

Asp increases from 0.05 to 1, FIG. 4a also captures the emergence of the sticky Rouse region²², which involves the random breaking and reformation of reversible stickers and persists with a characteristic slope of 2 till the entire associative polymer relaxes. To the best of the authors' knowledge, there are very few studies on associative polymers with sticker molar fractions greater than 0.2 due to the drastically increased T_{g} and the cooperative motion of the nearby stickers for linear polymers.^{27,28} The high T_{g} and coupled sticker dynamics could delay the network relaxation by more than eight decades in frequencies (e.g., the telechelic ionomers), thus hindering its thermal processability for detailed rheological study. As a result, the sticky Rouse region for highly functionalized polymer remains mostly unexplored. In response, bottlebrush architecture—long, unentangled, and end-functionalized sidechains weakens the T_{g} increasing trend (FIG. 2) and even decouples the cooperative associations of nearby stickers (illustrated below), therefore granting us unprecedented access into this region. In FIG. 4c, by reshifting the master curves to their isofrictional temperatures, T_{g}+35, the delay in subsequent relaxations caused by the T_{g} changes is normalized, as evidenced by the data collapse for all bottlebrushes in the high-frequency region. The sticker lifetime τₛ, identified as the inverse of either G′ and G″ crossover frequency (circa 10⁻⁴ rad/s in FIG. 4c) or the frequency where tan δ=1 (FIG. 4d), is thereby revealed to be independent of p. This observation implies that the association and dissociation of UPy pairs on sidechain ends are random and decoupled even asp reaches 1. The τₛ alone governs the transition between the elastic network region and the viscoelastic stress dissipating (i.e., sticky Rouse) region, which, for the first time, stretches across more than four decades in frequency, as seen for pNb³⁰⁰-pMCL¹⁷-UPy¹⁰⁰ in FIG. 5i-j. Therefore, the nearly constant τₛ for UPy-functionalized bottlebrush networks with moduli ranging between 27 kPa and 1.6 MPa should allow self-healing or reforming the broken UPy pairs at a similar elevated temperature. However, bottlebrushes with higher p and more extended sticky Rouse regions may need longer to heal completely.

### Mechanical Properties and Self-Healing of the First Example

In FIG. 5a, two UPy-functionalized pMCL bottlebrushes (pNb⁶⁰⁰-pMCL¹⁷-UPy⁶ and pNb³⁰⁰-pMCL¹⁷-UPy²⁵) display drastically different plateau moduli but a similar softening temperature (circa 40° C.), where the G′ and G″ cross over representing the transition from an elastic solid to a viscoelastic liquid upon heating. Such behavior is also perfectly reversible upon cooling, thus predicating its self-healing ability. As expected from the similar τₛ in FIG. 4, our hydrogen-bonded bottlebrush networks with widely tunable network moduli should self-heal at or above the approximately same softening temperature. FIG. 5b depicts a quick self-healing test by joining a precut sample (pNb⁶⁰⁰-pMCL¹⁷-UPy⁶) at 35° C. for 5 mins and then stretching at room temperature, clearly revealing the healed joint.

To further explore the self-healing ability of hydrogen-bonded bottlebrush networks, we subject two bottlebrushes with different Gₓ (27 kPa versus 261 kPa) but the same N_{SC} and N_{BB} to the uniaxial tension tests at room temperature before and after the repeated reprocessing. FIG. 5c compares the stress-strain curves for pNb³⁰⁰-pMCL¹⁷-UPy²⁵ after the following processes: (1) a pristine specimen molded at 100° C. for one minute; (2) the chopped specimen from (1) remolded at the same condition; (3) the chopped specimen from (2) molded at the same condition for the third time. An engineering strain rate of 2.0 s⁻¹ is chosen well within the network plateau region where elasticity dominates. A standard hot press and dogbone punch is used to obtain the samples for testing. In all cases, similar values of the strain-at-break (circa 200%) and toughness were achieved upon repeated reprocessing for pNb³⁰⁰-pMCL¹⁷-UPy²⁵. Due to the extreme softness and tackiness of pNb³⁰⁰-pMCL¹⁷-UPy⁵, we resort to the axial tension test on a filament-shaped sample in the rheometer instead of the standard dogbone sample in the tensile tester. Fully automated steps are set up to ensure the same filament dimension with no thermal and stress history and identical axial test conditions across multiple runs at room temperature. Because the filament diameter is not perfectly constant across its length, possibly due to the gravity effect during reprocessing at 100° C., raw force and displacement signals are plotted instead of intensive variables (i.e., stress or strain). FIG. 5d compares the force-displacement curves for sample pNb³⁰⁰-pMCL¹⁷-UPy⁵ before and after sample rupture and reprocessing. The sample appears to be consistently healed close to the pristine state regarding the displacement-at-break (circa 40 mm) and peak force (0.6-0.7 N). Overall, both samples with network moduli differing by one order of magnitude show quick and excellent self-healing ability via reprocessing at 100° C., which is much lower than 160° C. in our previous work on the covalent adaptive bottlebrush network¹.

The excellent mechanical recovery for our UPy-functionalized bottlebrushes in FIGS. 5c and 5d likely stems from the fast repeated breakup and reforming of UPy pairs across the fractured interface at temperatures above the softening point, where the sticky Rouse dynamics dominate. However, recent simulation results show that equilibrium healing can only occur with healing time longer than the terminal relaxation time when the linear polymer has diffused across the interface with a displacement comparable to their own size.²⁹ Therefore, more extensive self-healing experiments are needed to understand the impact of bottlebrush architecture on the pair association and diffusion across the fractured interface. Finally, we expect the values of N_{BB} and N_{SC} can manipulate the tensile behavior in FIGS. 5c and 5d. These studies highlight the self-healing and recyclability of hydrogen-bonded bottlebrush polymer elastomers.

### Tensile Testing Methods

### Tensile Testing of Bottlebrush Polymers

To further probe self-healing properties, pNb³⁰⁰-pMCL¹⁷-UPy⁵ and pNb³⁰⁰-pMCL¹⁷-UPy²⁵ were subjected to uniaxial tension tests.

Uniaxial tensile testing of pNb³⁰⁰-pMCL¹⁷-UPy²⁵ was performed with a TA.XTplusC texture analyzer equipped with A/MTG tensile grips. Samples were clamped without additional adhesive. Uniaxial tension data for pNb³⁰⁰-pMCL¹⁷-UPy⁵ was collected on an ARES-G2 rheometer from TA Instruments. The strain rate was set at 2 s⁻¹, which was chosen based on the rheological master curve to occur within the network plateau region where elasticity dominates.

Tests were set up to compare pristine and reprocessed samples. Due to the softness and stickiness of pNb³⁰⁰-pMCL¹⁷-UPy⁵, a standard sample preparation was not possible. Instead, a rheometer was used as a fully automated system to provide similar test conditions across multiple runs as illustrated in FIGS. 5b, 5k, and 5l. First, 90 mg of material was placed on the stainless-steel plate (diameter=8 mm). The gap was reduced to make good contact with the material. The material was then heated to 100° C. before shearing at 0.25 rad/s for 150 s. The gap was then slowly reduced further until the material covered the entire plate before shearing at 0.1 rad/s for 150 s. The material was then allowed to relax at 100° C. for 60 s before pulling at 0.5 mm/s to form a 7 mm rod (FIG. 5k). The material was then cooled to 25° C. at approximately 20° C./min and allowed to relax for 10 min.

After the preparation was done, the test was performed by pulling the material at 4.11 mm s⁻¹. The pulling rate was extracted from the rheological master curve of the sample to fall under the network plateau region where elasticity dominates. After rupture was observed, the sample was automatically resubjected to the preparation described above. The test was performed 2 more times.

Samples for tensile testing were prepared by heat pressing into a metal rectangular mold (8 mm wide×15 mm long×0.5 mm thick) between two PTFE sheets at 100° C. for 1 min using 1 metric ton of force (FIG. 5m). The sample was punched into a dog bone shape (10 mm long×1.5 mm wide×0.5 mm thick) using a brass punch. The strain rate was 2 s⁻¹.

### Further Information on Synthesis of the First Example

### Isomerization of cis-5-Norbornene-exo-2,3-dicarboxylic anhydride (exo-Nb)

The isomerization was performed according to the literature.¹ In a round bottom flask charged with a stir bar, cis-5-norbornene-endo-2,3-dicarboxylic anhydride (endo-Nb) (250 g, 1.5 mol) was added. The reaction flask was fitted with a condenser column and heated to 180° C. for 12 hours while stirring followed by recrystallization in benzene. After 4 more iterations of recrystallization, excess benzene was decanted and the product was dried in vacuo. Yield: 40% (100 g).

¹H NMR (CDCl₃) δ 6.33 (t, J=2.0 Hz, 2H), 3.45 (t, J=1.8 Hz, 2H), 3.00 (d, J=1.5 Hz, 2H), 1.67 (dt, J=10.3, 1.6 Hz, 1H), 1.44 (dt, J=10.2, 0.7 Hz, 1H).

¹³C NMR (CDCl₃) δ 171.69, 138.10, 48.90, 47.01, 44.25.

### Synthesis of N-(hydroxyethyl)-cis-5-norbornene-exo-2,3-dicarboximide (Nb—OH)

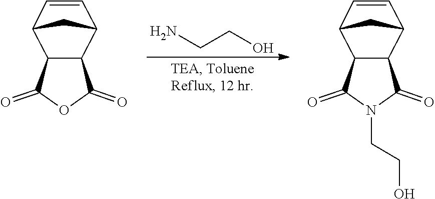

The synthesis was performed according to literature.¹ In a round bottom flask, exo-Nb (40 g, 121.8 mmol), ethanolamine (15.6 g, 15.4 mL, 127.9 mmol), triethylamine (2.7 g, 3.7 mL, 13.4 mmol), and toluene (500 mL) were added. A Dean-Stark trap and a condenser column were attached on top of the reaction flask. The reaction mixture was heated to 100° C. until dissolution to prevent excessive foaming. Then the reaction was allowed to reflux at 110° C. for 12 hours. The product was concentrated in vacuo and redissolved in chloroform. The solution was washed with 0.1 M HCl solution and repeatedly washed with water. The combined organic layers were dried over anhydrous MgSO₄ and concentrated in vacuo to yield a solid white powder as the product. The crude product was recrystallized from chloroform to obtain large transparent crystals. Yield: 63% (35 g).

¹H NMR (CDCl₃) δ 6.32 (d, J=2.0 Hz, 2H), 3.80 (t, J=5.2 Hz, 2H), 3.77-3.70 (m, 2H), 3.31 (d, J=1.9 Hz, 2H), 2.74 (s, 2H), 2.05 (s, 1H), 1.54 (d, J=9.9 Hz, 1H), 1.37 (d, J=11.4 Hz, 1H).

¹³C NMR (126 MHz, CDCl₃) δ 178.88, 137.97, 60.66, 48.04, 45.43, 42.93, 41.49.

### Synthesis of γ-methyl-ε-caprolactone (MCL)

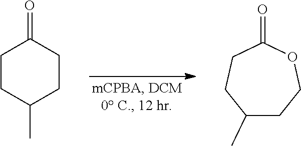

The synthesis was performed according to literature.⁶ In a large Erlenmeyer flask, meta-chloroperoxybenzoic acid (mCPBA) (≤77%, 100 g, 579 mmol) was added into dichloromethane (1 L) at 0° C. while stirring. 4-Methylcyclohexanone (43.3 g, 47 mL, 386 mmol) was added dropwise into the stirring solution. The reaction solution was slowly warmed to room temperature overnight. The white solid byproduct was then removed by vacuum filtration and rinsing with DCM. The filtrate volume was then reduced in vacuo by ½ the original volume and the remaining solution was cooled to 0° C. in an ice bath before again filtering off the white solid. The filtered solution was washed with 10% w/v sodium bisulfite solution (3×150 mL), saturated sodium bicarbonate solution (3×150 mL), and water (3×150 mL). The combined organic layers were dried over anhydrous MgSO₄. The product was then passed through a plug of basic alumina and dried in vacuo. The product was dried over calcium hydride (5 wt %) for 12 hours before fractional distillation under dynamic vacuum (100-500 mTorr, 75-95° C.). This was repeated 2 more times. Then, the product was distilled over Sn(Oct)₂ (0.025% wt) 2 more times to yield a transparent colorless liquid. Yield: 70-80%.

¹H NMR (CDCl₃) δ 4.29-4.22 (m, 1H), 4.16 (dd, J=12.9, 10.4 Hz, 1H), 2.69-2.55 (m, 2H), 1.95-1.89 (m, 1H), 1.88-1.83 (m, 1H), 1.80-1.71 (m, 1H), 1.53-1.44 (m, 1H), 1.32 (m, J=14.3, 11.8, 2.1 Hz, 1H), 0.98 (d, J=6.6 Hz, 3H).

¹³C NMR (126 MHz, CDCl₃) δ 176.17, 68.20, 37.35, 35.38, 33.32, 30.88, 22.24.

### Synthesis of 2(6-isocyanatohexylaminocarbonylamino)-6-methyl-4[1H]pyrimidinone (UPy-isoCy)

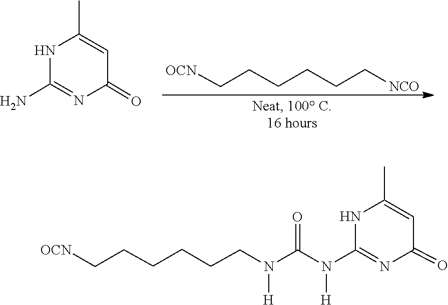

The synthesis was performed according to literature.⁵ In a round bottom flask charged with a stir bar, 2-amino-4-hydroxy-6-methyl pyridine (10 g, 79 mmol) and hexamethylene diisocyanate (91 g, 543 mmol) were added. The mixture was heated to 100° C. while stirring for 16 hours. The reaction was cooled to room temperature before precipitating into pentanes. The precipitate was repeatedly washed with pentanes before drying in vacuo. The crude product was recrystallized from 2:3 acetone:chloroform three times and dried in vacuo to yield white crystal. Yield: 70% (16 g).

¹H NMR (CDCl₃) δ 13.09 (s, 1H), 11.85 (s, 1H), 10.17 (s, 1H), 5.80 (s, 1H), 3.50-2.99 (m, 4H), 2.21 (s, 3H), 1.60 (d, J=7.0, 4.7 Hz, 4H), 1.51-1.23 (m, 4H).

¹³C NMR (CDCl₃) δ 173.07, 156.59, 154.70, 148.30, 121.87, 106.69, 42.89, 39.79, 31.20, 29.31, 26.24, 26.18, 18.95.

FT-IR: 2293.95, 2280.34, 1698.21, 1665.27, 1575.86, 1523.59, 1461.50, 1411.48, 1357.14, 1310.56, 1254.58, 1175.71, 1140.80, 936.52, 873.97, 767.44, 741.63, 601.51, 566.73 cm⁻¹.

### Synthesis of norbornene-poly(4-methylcaprolactone) (Nb-pMCL)

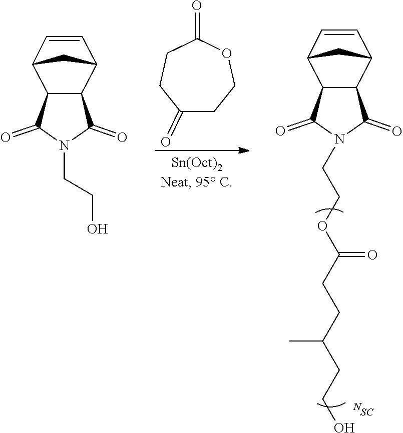

The synthesis was performed according to literature.³ All glassware was dried in an oven for 24 h prior to the synthesis. Samples are referred to as Nb-pMCL^{N}^{_{SC}} where N_{SC} is the degree of polymerization. For example, Nb-pMCL¹⁷ was synthesized by the following procedure. In a nitrogen-filled glove box, Nb—OH (4.93 g, 23.7 mmol), methylcaprolactone (70 g, 77 mL, 547 mmol), and Sn(Oct)₂ (0.11 g, 0.087 mL, 0.273 mmol) were added into a thick-walled pressure flask charged with a stir bar and a bottom-seating PTFE lined cap and a perfluoro O-ring. The flask was sealed before removing it from the glovebox. The reaction vessel was submerged into a preheated 95° C. oil bath and reacted for 115 minutes while stirring, followed by quenching in an ice-water bath for several minutes. An aliquot of the product was extracted and the final conversion was determined to be 70% via ¹H NMR. The product was precipitated into room temperature hexanes, given time to settle at the bottom of the flask, and then slowly decanted. After 5 more precipitations, the product was concentrated in vacuo to yield a transparent colorless liquid. The molecular weight and dispersity were determined by ¹H NMR and SEC respectively. Yield: 85% (45 g).

### Synthesis of UPy-Functionalized pMCL Macromonomer (Nb-pMCL^{N}^{_{SC}}-UPy)

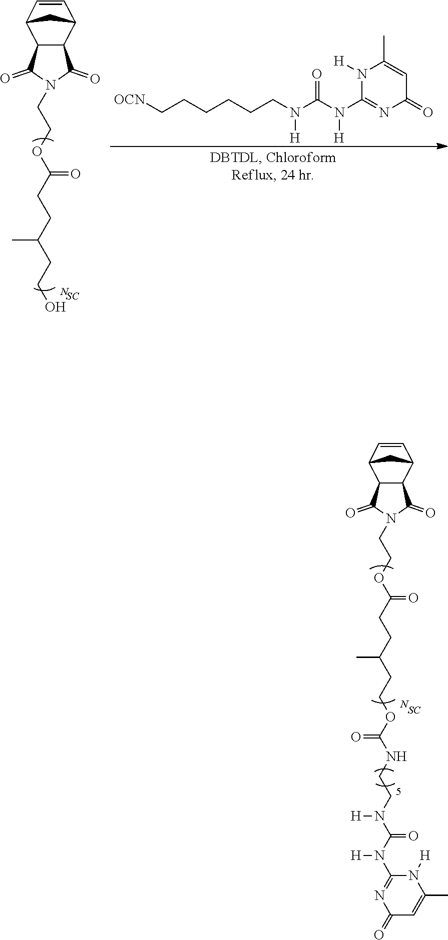

The synthesis was performed according to literature.⁵ All glassware was oven-dried for 24 hours prior to the synthesis. In a 3-neck round bottom flask, Nb-pMCL¹⁷ (Mₙ=2.7 kDa, 1 eq, 5 g, 1.85 mmol), UPy-isoCy (1.5 eq, 0.81 g, 2.78 mmol), and catalytic amount of dibutyltin dilaurate (DBTDL) were added. A reflux condenser was attached and the reaction mixture was refluxed for 24 hours under nitrogen after adding 50 mL of anhydrous chloroform. After cooling to room temperature, acetone was added and the remaining solids were removed by filtration through celite. This process was repeated 3 times. The filtrate was concentrated in vacuo and precipitated in methanol at −78° C. three times. The transparent, colorless liquid was collected and dried in vacuo. The completion of the reaction was confirmed via ¹H NMR and FT-IR. Yield: 95% (5.1 g)

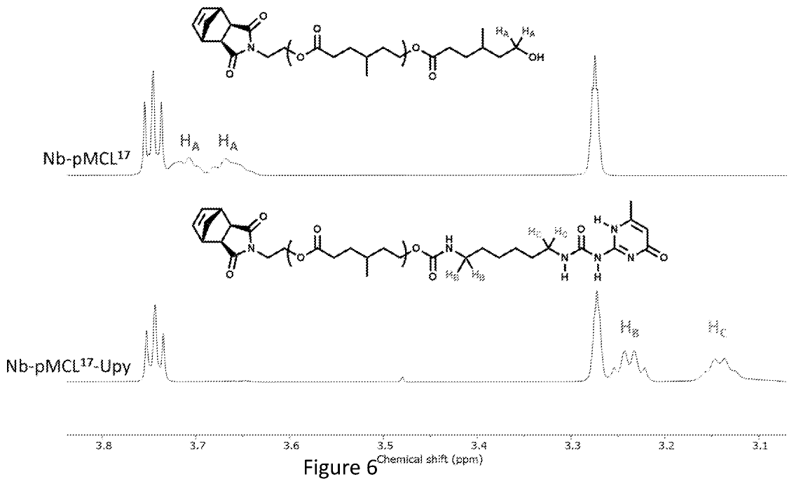

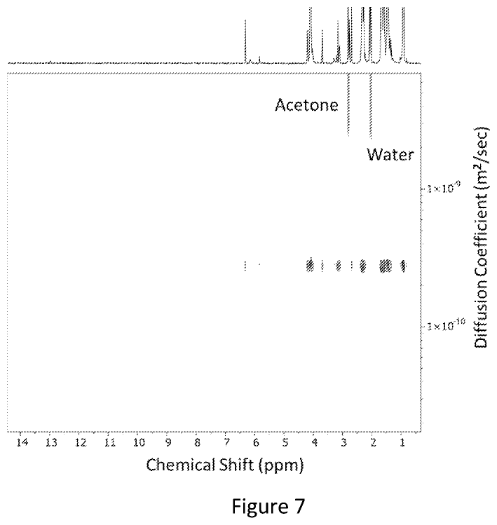

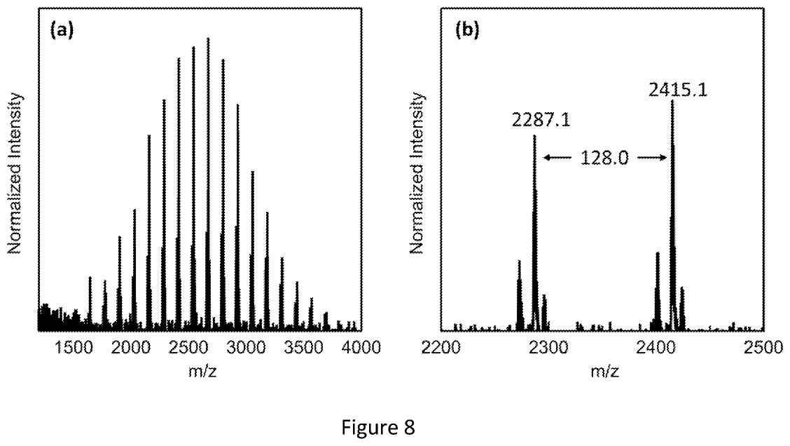

To further confirm the removal of unreacted UPy-isoCy, ¹H DOSY experiments were conducted. Deuterated acetone was used as a solvent to break potential hydrogen bonding interactions. The appearance of a single species and diffusion coefficient suggests complete removal of unreacted UPy-isoCy (FIG. 7). In addition, MALDI MS shows separation of each main population at 128 m/z corresponding to one monomer unit (FIG. 8).

### Synthesis of Nb-pMCL and Nb-pMCL-UPy Statistical Bottlebrush Copolymers

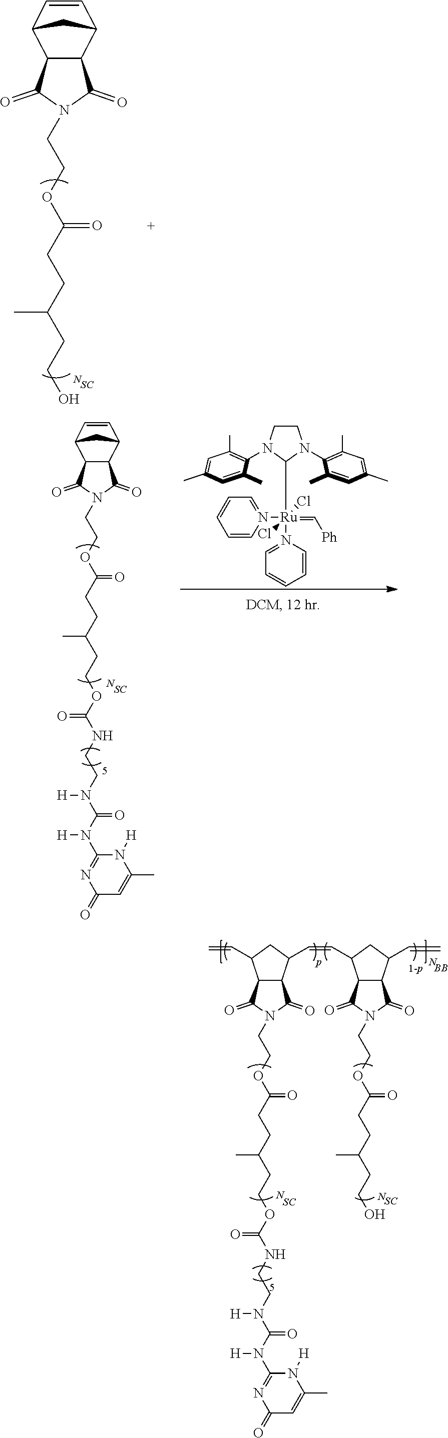

Statistical polymerization of the macromonomers using a Grubbs' third-generation catalyst (G3) was performed in a very dilute solution of the macromonomers. Samples are referred to as pNb^{N}^{_{BB}}-pMCL^{N}^{_{SC}}-UPy^{p}. The % UPy was controlled by the ratio of Nb-pMCL^{N}^{_{SC}} and Nb-pMCL^{N}^{_{SC}}-UPy macromonomers. For example, a bottlebrush polymer pNb³⁰⁰-pMCL¹⁷-UPy¹⁰ was synthesized by the following procedure. In a nitrogen-filled glovebox, Nb-pMCL¹⁷ (1 g, 0.4 mmol, 270 eq) and Nb-pMCL¹⁷-UPy (0.12 g, 0.04 mmol, 30 eq) were dissolved in anhydrous DCM (40 mL). In a separate container, G3 (0.97 mg, 0.0013 mmol, 1 eq) was dissolved in 0.2 mL of anhydrous DCM before rapid injection into a vigorously stirring solution of the macromonomers. After 12 hours, the polymerization was removed from the glovebox and terminated using a large excess ethyl vinyl ether (EVE) (>100 eq) with stirring for 30 minutes. A crude ¹H NMR of the freshly quenched reaction was taken. The disappearance of a peak at 6.3 ppm corresponding to unreacted olefin protons was observed suggesting high reaction conversion. The resulting reaction mixture was concentrated in vacuo and the polymer precipitated into methanol at 0° C. After two more precipitations into methanol, the bottlebrush polymer was dried in vacuo. The actual mol % UPy in the polymer was determined with ¹H NMR. The dispersity of the polymer was determined by SEC in THF.

The mol % UPy in the product was calculated by normalizing the methyl protons of the pMCL sidechain (0.9 ppm) to the amounts observed in the macromonomer; the integrations of UPy amine protons was then calculated at 10.1 ppm, 11.8 ppm, and 13.1 ppm. The mol % UPy in the polymer is an average of the number calculated from these three peaks.

NMR of the these various compounds can be found in Appendix B of the priority application for this application (Ser. No. 63/392,363) which is incorporated by reference herein.

### Characterization Methods Used for Data Obtained Herein

All ¹H nuclear magnetic resonance (NMR) spectra were collected using a Varian Unity Inova AS600 600 MHz equipped with a 5 mm Varian triple resonance ¹H/¹³C/¹⁵N inverse detection probe with z-axis pulsed field gradient (PFG). Small molecule JH and ¹³C NMR were collected using a Bruker Avance NEO 500 MHz equipped with a CryoProbe Prodigy BBO probe with z-axis PFG. Chemical shifts (δ) are reported in ppm relative to residual undeuterated CHCl₃ in CDCl₃ (7.26 ppm), CD₂Cl₂ (5.32 ppm), or acetone-d₆ (2.05 ppm) for ¹H NMR spectra and CDCl₃ (77.16 ppm) for ¹³C NMR spectra. The following abbreviations (or combinations thereof) were used to describe the multiplicities: s (singlet), d (doublet), t (triplet), q (quartet), in (multiplet). ¹H diffusion-ordered spectroscopy (DOSY) experiments were performed on a Varian Unity Inova AS600 600 MHz using bipolar gradient pulses stimulated echo sequence with convection compensation. The sample solution was kept at approximately 20 mg/mL with no spinning to avoid convection. The acquisition was done at 16 gradient steps and 16 at each scan. DOSY analysis was performed with MestreNova software using Bayesian data fitting.

Size exclusion chromatography (SEC) was performed on a Waters e2695 Separations Module system using Agilent PLgel columns and a differential refractive index detector with tetrahydrofuran (THF) as the mobile phase at 35° C. with a flow rate of 0.3 mL/min. Molar masses and molar-mass dispersities (Ð) were determined against narrow polystyrene standards (Agilent Technologies, EasiVial).

Infrared (IR) spectra were collected using a Nicolet is10 FTIR equipped with a Smart Diamond attenuated total reflectance (ATR) accessory. Data were collected between 4000 to 500 cm⁻¹ with 64 scans.

Time-of-flight matrix-assisted laser desorption/ionization mass spectrometry (MALDI-TOF MS) was performed on a Bruker Microflex LRF MALDI-TOF equipped with a 60 Hz nitrogen laser at 337 nm. Calibration was performed with a peptide 2 standard mixture containing Bradykinin Fragment 1-7, Angiotensin II, Angiotensin I, Substance P, Bombesin, Renin Substrate, ACTH clip 1-17, ACTH clip 18-39, and Somatostatin 28. Samples were prepared in a dithranol/CHCl₃ solution. The laser intensity was set at 30%.

Differential Scanning Calorimetry (DSC) was performed on a TA instrument Q2000 DSC with three repeated cycles between −100 and +100° C. at a constant rate of 10° C./min. Only the second heating scan is shown in this manuscript.

Uniaxial tensile testing of pNb³⁰⁰-pMCL¹⁷-UPy²⁵ was performed with a TA.XTplusC texture analyzer equipped with A/MTG tensile grips. Samples were clamped without additional adhesive. Unixial tension data for pNb³⁰⁰-pMCL¹⁷-UPy⁵ was collected on an AES-G2 rheometer from TA Instruments. The strain rate was set at 2 s⁻¹ which was chosen based on the rheological master curve to occur within the network plateau region where elasticity dominates.

A strain-controlled ARES-G2 rheometer equipped with a liquid nitrogen dewar from TA Instruments was used to investigate the linear viscoelastic and tensile properties of hydrogen-bonded bottlebrush polymers. For master curve generation, isothermal frequency sweeps between 100 and 0.1 rad/s were collected using a strain amplitude of 1%-5% from a high (100 or 70° C.) to low (−40 or −50° C.) temperature with increments ranging from 30 to 10° C. To verify thermal reversibility, a temperature ramp was performed by heating from −50 to 100° C. and then cooling at a rate of 5° C./min using an auto strain amplitude ranging between 1% and 50% within the linear region and a frequency of 1 rad/s. Rheological master curves were constructed using time-temperature superposition (TTS) following the Williams-Landel-Ferry (WLF) relation.

### Example H-Bonding Groups

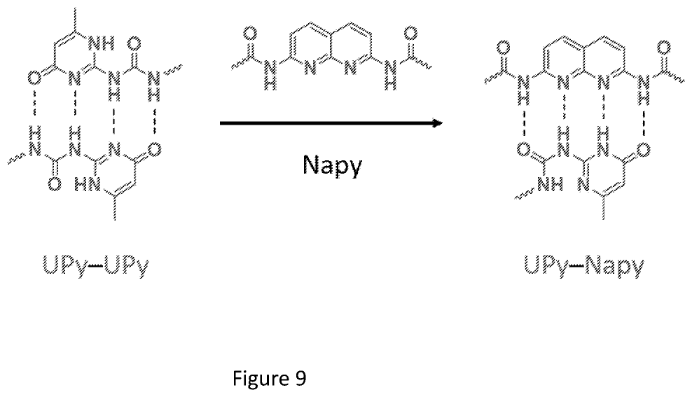

We note that there are many other types of hydrogen bonding groups that can be used to control the strength of the bonding between these dynamic crosslinking groups. UPy is a donor-donor-acceptor-acceptor (DDAA) self-complementary motif, which means it binds to itself, but there are also other options with fewer H-bonds or more selective interactions. One attractive alternative that we propose to study is Napy, which can selectively displace UPy because it forms stronger Napy-UPy interactions than UPy-UPy bonds (FIG. 9). Note that this interaction occurs with tautomerization of the UPy to generate a DAAD quadruple hydrogen bond motif. We predict demonstration of this type of selective interaction in super-soft materials, small molecule Napy derivatives, which, when blended with a Upy-containing bottlebrush, should decrease the plateau modulus by breaking some Upy-Upy bonds. This would be a complementary mechanism to tune the softness of H-bonding bottlebrush polymers. This effect can be studied as a function of Upy loading and Napy concentration to identify the softest materials that can be accessed before a loss of network connectivity.

### Example Side Chains

The side chains can comprise at least one polymer selected from a polyester, a polylactide, a poly(ether), a poly(siloxane), a polyacrylate, a polymethacrylate, a polyamide, a polyacrylamide, a polyurea, a polycarbonate, a polyalkane, a polyethylene, a polypropylene, a polyisobutylene, a polyalkene, a polybutadiene, a polyisoprene, a polystyrene, or the combination thereof.

### Example Applications Taking Advantage of Properties of H-Bonding Bottlebrush-Polymers

H-bonded bottlebrush polymers may be used as a new class of super-soft elastomers for various applications. For example, based on knowledge of the melt rheology, they may be used as shear-thinning inks in extrusion-based 3D printing. Another application includes using dual networks—one derived from covalent benzophenone crosslinking and the other from transient hydrogen bonds—to create super-soft, shape memory materials. EMH-bisBP may be used to create crosslinked P4MCL networks containing Upy groups; the hydrogen bonding allows some plasticity to create a temporary shape, while subsequent heating will return the material to the original shape as fixed by the permanent covalent network.

Other possible applications include surgical tape for wound dressing which is stretchable while maintaining super-soft elasticity response after application and stretchable and deformable microfluidic device.

### Advantages and Improvements

Investigation of the thermal, linear viscoelastic, and self-healing behavior of a hydrogen-bonded pMCL bottlebrush network shows these materials can be beneficial as reprocessable, super-soft elastomers and potentially with unique energy dissipation mechanisms.

The impact of the associative Upy moieties on the polymer dynamics across different length scales is either diluted or decoupled because of the bottlebrush architecture. The much weaker dependence of T_{g} on the Upy molar fraction is attributed to the dilution effect of unentangled sidechains on the segmental dynamics. A longer and entangled sidechain can even reduce T_{g} and delay subsequent relaxations due to the increased free volume away from the congested backbone and slowly retracting sidechains, respectively. However, surprisingly, attaching the Upy moiety to the sidechain ends doesn't alter the Upy pair's binding strength, with only slightly higher activation energy for our bottlebrushes (41-47 kJ/mol) than the linear analog (33-37 kJ/mol). In stark contrast with the linear telechelic ionomers, the hydrogen-bonded bottlebrush polymers show no sign of the cooperative motion of nearby Upy pairs or stickers, even with Upy moiety attached to every sidechain end. As a result, the G′ and G″ crossover frequency, which represents the transition from elastic solid to viscoelastic liquid, is independent of Upy amount and governed solely by the sticker lifetime. Beyond the sticker lifetime, the dynamics of viscoelastic liquid are controlled by the sticky Rouse motion, which extends as the backbone length or the Upy amount increases. In the limiting case of a fully functionalized bottlebrush, the sticky Rouse region can stretch over four decades in frequency with no sign of terminal response. Fortunately, this extended sticky Rouse motion doesn't prevent self-healing after mild heating at 100° C. for our bottlebrushes across a wide range of network moduli. This similar self-healing ability from super-soft to stiff materials originates from the fact that the amount of Upy only alters the network moduli linearly but not the sticker lifetime. We anticipate the bottlebrush architecture as a new design parameter to modulate the associative polymer dynamics and produce self-healable materials with widely tunable moduli as novel adhesives and biomimetics and artificial skin.

### Process Steps

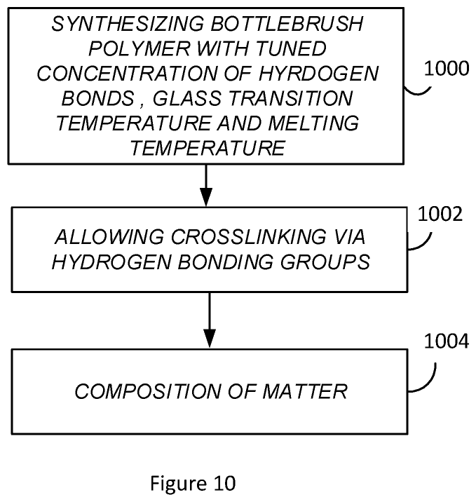

FIG. 10 is a flowchart illustrating a method of making a composition of matter.

Block 1000 represents synthesizing a plurality of bottlebrush polymers with a selected concentration of hydrogen bonds.

In one example, the synthesizing comprises monomer first synthesizing comprising covalently bonding first sidechains to second sidechains via a backbone, each of the first side-chains comprising a linker compound terminated with a cross-linker compound comprising a hydrogen bonding group and each of the second side-chains without the linker compound and without the cross-linker compound.

In another example, the synthesizing comprises bottlebrush first synthesis wherein the bottlebrush polymers comprising sidechains are synthesized and then crosslinker compounds comprising hydrogen bonding groups are covalently bonded to only some of the sidechains.

The concentration of the hydrogen bonds is tuned (e.g., via the ratio of the first sidechains to the second sidechains) and the number of sidechains having a glass transition temperature T_{g} and melting temperature Tₘ below minus twenty degrees Celsius are selected so that the composition of matter is amorphous and/or comprises an elastomer having at least one of a modulus less than 100 MPa, or less than 10 MPa, or less than 1 MPa at a temperature 23° C. or a melting temperature Tₘ less than 30° C.

In one or more examples, the step comprises providing an amount of the cross-linker compounds in the bottlebrush polymers to obtain a desired elastic modulus of the composition of matter in range where the elastic modulus of the composition of matter is a linear function of the amount of cross linker compound. For example, the function may be a straight line characterized by a first fitting parameter (a) and a second fitting parameter (b), wherein the first fitting parameter is proportional to the slope of the straight line and a y-intercept of the straight line is proportional to the second fitting parameter, and the first fitting parameter and the second fitting parameter are extracted by fitting the measured elastic moduli with the function for various compositions of matter having different side-chain and backbone lengths and crosslinker loadings.

Block 1002 represents allowing crosslinking of the bottlebrush polymers via the hydrogen bonding groups.

Block 1004 represents the end result, a composition of matter.

Illustrative embodiments of the composition of matter include, but are not limited to, the following (referring also to FIGS. 1-9).

1. A composition of matter 100, comprising, consisting, or consisting essentially of:
a plurality of bottlebrush polymers 102, each of the bottlebrush polymers comprising:
   a backbone 104 including a plurality of monomer units; and
   a plurality of side-chains 106 attached to the backbone; and one or more of the side-chains each comprising a linker compound 108 terminated with a cross-linker compound 110 comprising a hydrogen bonding group; and
a plurality of hydrogen bonds 112 forming reversible bonds between the hydrogen bonding groups of cross-linker compounds in different ones of the bottlebrush polymers, so as to form cross-links between different one of the bottlebrush polymers; and
wherein a concentration of the hydrogen bonds is tuned and the one or more of the side-chains each have at least one of a glass transition temperature T_{g} or a melting temperature Tₘ below minus twenty degrees Celsius so that the composition of matter is amorphous and/or comprises an elastomer having at least one of a modulus less than 1 MPa at a temperature 23° C. or a melting temperature Tₘ less than 30° C.

2. The composition of matter of example 1, wherein −140° C.≤Tₘ, Tg<20° C.

3. The composition of matter of example 1, wherein the cross-linker compounds are each a 2-ureido-4[1H]-pyrimidinone of the structure

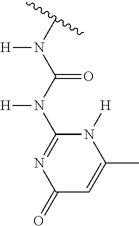 [SMILES: *NC(=O)Nc1nc(=O)cc(C)[nH]1]

4. The composition of matter of any of the examples, wherein one or more of the cross-linker compounds are terminated by the hydrogen bonding group comprising an oxygen, nitrogen, fluorine, sulfur or other moiety capable of attaching to a reversible hydrogen bonding moiety.

5. The composition of matter of any of the examples, wherein the side-chain comprises a poly(4-methylcaprolactone) or a poly(4-methyl-F-caprolactone).

6. The composition of matter of any of the examples, wherein a molar fraction p of the side-chains that contain a cross linker end group in each of the bottlebrush polymers is 0.1≤p≤0.8, where p=number of moles of cross-linker compounds per unit weight of bottlebrush polymer divided by the total number of moles of the side-chains per unit weight of the bottlebrush polymer.

7. The composition of matter of any of the examples, wherein the monomer units before polymerization comprise a norbornene, a styrene, an acrylate, a (meth)acrylate, or an acrylamide.

8. The composition of matter of any of the examples, wherein the backbone has the structure:

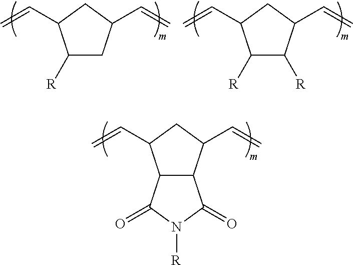

and m is an integer and R is a side-chain.

9. The composition of matter of any of the examples, wherein the backbone has the structure:

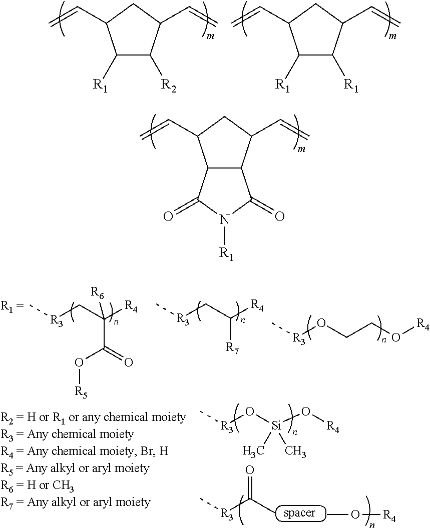

wherein R₄ can be any chemical moiety, Br, H or crosslinker; the spacer can be any alkyl or aryl moiety, including CH₂CH(R₅)CH₂CH₂CH₂, CH₂CH₂CH(CH₃)CH₂CH₂, CH₂CH₂CH(R₅)CH₂CH₂, CH₂CH₂C(R₅)₂CH₂CH₂, CH₂CH₂CH₂CH(R₅)CH₂, CH₂CH₂CH₂CH₂CH(R₅), CH₂CH(R₅)CH₂CH₂, CH₂CH₂CH₂CH(R₅) and CH₂CH₂CH(R₅)CH₂. and m, n are integers.

10. The composition of matter of any of the examples, wherein the side-chains comprise at least one of a polyester, an oligomeric ester, a polyether, an oligomeric ethylene oxide, a poly(ethylene oxide), an oligomeric propylene oxide, a poly(propylene oxide), an oligomeric propylene, polypropylene, an oligomeric isobutylene, a polyisobutylene, a poly(dimethylsiloxane), an oligomeric dimethylsiloxane, an oligomeric acrylate, polyacrylate, or a polystyrene.

11. The composition of matter of any of the examples, wherein the cross-linker compounds comprise at least one of a N-propylthymine, an aminopyridine, a diaminopyridine, an acetylpyridine, a diacetylaminopyridine, an aminopyrimidine, diamonopyrimidine, an acetylpyrimidinone, a diacetylpyrimidinone, an aminotriazine, a diaminotriazine, an ureidotriazine, an ureidopyrimidinone, a N-carbamoyl squaramide, a 2,7-bis(acylamino)-1,8-naphthyridine, a pyridylurea, a dipyridylurea, or a dipyrimidinylamine.

12. The composition of matter of any of the examples, wherein T_{g}, Tₘ, and an amount of the crosslinker compounds in the bottlebrush polymers are selected such that the bottlebrush polymers form an elastomer with a uniaxial tensile elastic modulus in a range of 100 Pa to 1 MPa at a temperature in a range of −20° C. to 50° C. or −20° C. to 40° C.

13. The composition of matter of any of the examples, further comprising:
an amount of the crosslinker compounds in the composition of matter selected or tuned such that the composition of matter has a shear modulus in a range of 100 Pa to 1 MPa as measured by a rheometer when strain rate is in a range of 1 s⁻¹ to 5 s⁻¹, the tensile strain is applied at a frequency in a range of 0.1 to 100 rad/s using a strain amplitude of 1%≤strain amplitude≤5% in a temperature range of −40° C. to 100° C., or as measured by a texture analyzer using a strain rate of 2 s⁻¹. For example, the softer pNb³⁰⁰-pMCL¹⁷-UPy⁵ was measured using a rheometer and the less soft pNb³⁰⁰-pMCL¹⁷-UPy²⁵ was measured using a texture analyzer. See section entitled “Characterization Methods Used For Data Obtained Herein” on page 24.

14. An elastomer, actuator, adhesive, or pressure sensor comprising the composition of matter of any of the examples.

15. The composition of matter of any of the examples having the structure:

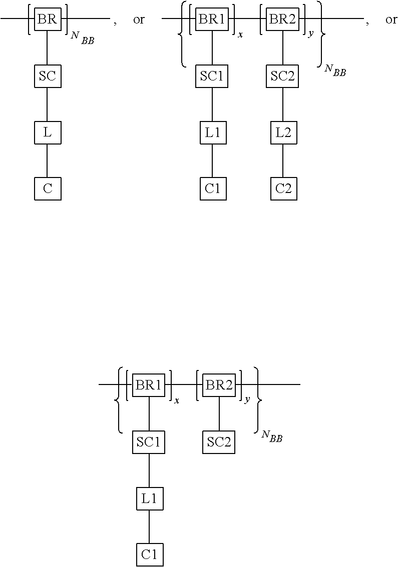

wherein:
BR, BR1, BR2 comprise the backbone monomer unit, BR1 and BR2 can be different or the same;
SC, SC1, SC2 comprise a linker side-chain moiety for linking the backbone to the linker compound, SC1 and SC2 can be different or the same;
L, L1, L2 comprise the linker compound, L1 and L2 can be different or the same; and
C, C1, C2 comprise the crosslinker compound, C1 and C2 can be different or the same.

16. The composition of matter of any of the examples, wherein the hydrogen bonds are such that the composition of matter reversibly transitions between an elastic solid and a viscoelastic liquid upon repeated heating and cooling cycles.

17. An adhesive comprising the composition of matter of example 18, wherein a degree of adhesion is tuned by the concentration of the hydrogen bonds.

18. The composition of matter of any of the examples, wherein a minimum temperature at which the self-healing can occur is at least 35° C. (FIG. 5b) or 40° C. (FIG. 5a) which is the softening temperature at which the hydrogen bonds starts to break and reform, and the polymer segments start to diffuse. The higher the temperature, the faster the self-healing. In one or more examples, a maximum temperature for self healing is any temperature below the decomposition temperature.

19. The composition of matter of example 16, 17, or 18, wherein the elastomer is self-healing between a temperature of 35° C. and a temperature below a decomposition temperature of the elastomer, and the self-healing is characterized by the elastomer reversibly transitioning between the elastic solid and the viscoelastic liquid upon repeated heating to the temperature of at least 35° C. and cooling to room temperature or to a temperature below 35° C. (e.g., 10 degrees Celsius).

20. The composition of matter of example 18 or 19, further comprising a composition of the hydrogen bonding groups and a concentration of the hydrogen bonding groups selected to obtain the self healing temperature.

21. An additive comprising the composition of matter of any of the examples.

In one or more examples, the additive comprises an additive having good compatibility wherein the bottlebrush polymers have good miscibility and chemical/thermal stability when blending with other materials (polymers, resin, plastic etc.) as additives. In one or more examples, the additive has a surface accumulation property wherein the bottlebrush polymers can self-aggregate to a surface or interface when blending with other materials as additives so as to modify the surface/interface property.

22. The composition of matter of any of the examples, wherein the composition comprises an elastomer at room temperature (e.g., 23 degrees Celsius), as defined by the composition of matter having Tg below 23 degrees Celsius or below 0 degrees Celsius and a modulus less than 1 MPa at the temperature of 23° C.

23. A hydrogen-bonded bottlebrush network formed by first end-capping the poly(4-methylcaprolactone)-based macromonomer with 2-ureido-4[1H]-pyrimidinone (UPy) moiety and then statistically polymerizing a mixture of the functionalized macromonomers and neat macromonomers at selected ratios. Attaching the UPy moiety to the free end of the sidechains dilutes the impact of additional friction of complementary UPy pair on the segmental dynamics, leading to a much weaker dependence of glass transition temperature (T_{g}) on the UPy molar fraction (p) than linear chains; while the activation energy to dissociate the UPy pair (41-47 kJ/mol) remains mostly unchanged. An even longer sidechain can result in a competing effect of reducing T_{g} and inducing entanglements on the hydrogen-bonded network dynamics. Increasing the backbone length only extends the sticky Rouse region without affecting the hydrogen-bonded network moduli (Gₓ) or the UPy pair dissociation time (τₛ). The Gₓ scales linearly with p and ranges from 27 kPa to 1.6 MPa, while τₛ remains nearly constant in contrast with linear telechelic ionomers, implying a similar self-healability across bottlebrush networks with different UPy amounts. These stretchable networks can undergo fast and almost perfect self-healing upon repeated rupture and melt press at 100° C. or lower. In summary, designing bottlebrush architecture is the key to manipulating the associative polymer dynamics and enabling facile self-healable materials with moduli from super-soft to stiff.

24. A bottlebrush architecture comprising a hydrogen-bonded polymer network dynamics capable of self-healing under mild heating for samples with widely different network moduli.

25. A polymer architecture, e.g., with self-healing using bottlebrushes containing side chains end-functionalized with 2-ureido-4[1H]-pyrimidinone (UPy) groups. The polymer is manufactured using three-step process: (1) synthesizing rubbery poly(4-methylcaprolactone) macromonomers (P4MCL-OH) with a norbornene-based initiator, (2) functionalizing the terminal hydroxyl group with UPy-isocyanate (P4MCL-UPy), and (3) statistically copolymerizing P4MCL-OH and P4MCL-UPy via ring-opening metathesis polymerization (ROMP) to form hydrogen-bonding bottlebrushes having a fraction (p) of side chains functionalized with UPy. Attaching UPy to the free end of bottlebrush side chains dilutes the impact of friction from complementary UPy interactions on segmental dynamics, leading to a much weaker dependence of glass transition temperature (T) on p than observed in linear analogues, while the activation energy to dissociate UPy-UPy bonds (41-47 kJ/mol) remains mostly unchanged. Even longer side chains result in a competition between reducing T_{g} and inducing entanglements that influence hydrogen-bonded network dynamics. Increasing the backbone length extends the sticky Rouse region without affecting the network modulus (Gₓ) or the UPy-UPy dissociation time (τₛ). Gₓ scales linearly with p and ranges from 27 kPa to 1.6 MPa, while r, remains nearly constant in contrast to linear telechelic ionomers, implying a similar self-healability across bottlebrush networks containing different amounts of UPy. These stretchable networks undergo fast and almost perfect self-healing upon repeated rupture and melt pressing at ≤100° C.

26. A bottlebrush architecture decorated with dynamic bonds creates opportunities to independently manipulate associative network dynamics and mechanical moduli with a synthetically accessible platform of materials.

27. The bottlebrush polymer of example 25, wherein:
the polymer is characterized by the G′ and G″ crossover frequency, which represents a transition from an elastic solid to viscoelastic liquid, being independent of the UPy mole fraction and is solely governed by the sticker lifetime; and
Dynamics within the viscoelastic liquid are controlled by sticky Rouse motion, which extends over wider ranges of frequencies as the backbone length and/or amount of UPy increases; and
in limiting case of a fully functionalized bottlebrush, the sticky Rouse region can stretch over four decades in frequency with no sign of a terminal response; and
the polymer exhibits self-healing after mild heating at 100° C. across a wide range of network moduli with similar self-healing ability from super-soft to stiff materials, e.g., due to the amount of UPy only altering the network modulus linearly, but not the sticker lifetime.

28. A bottlebrush with an architecture designed to modulate the dynamics
of hydrogen-bonding polymers, yielding self-healing materials with widely tunable moduli, e.g., for applications range from adhesives to artificial skin.

29. A bottlebrush polymer manufactured by a method comprising (1) synthesizing rubbery (e.g., with a poly(4-methylcaprolactone)) macromonomers with a norbornene-based initiator, (2) functionalizing the terminal (e.g., hydroxyl group) with a hydrogen bonding compound (e.g., UPy-isocyanate (P4MCL-UPy)) and (3) statistically copolymerizing the macromonomers and hydrogen bonding compound via ring-opening metathesis polymerization (ROMP) to form hydrogen-bonding bottlebrushes.

30. The composition of matter or method of any of the examples 1-29, wherein heating the composition of matter (comprising the bottlebrush polymers) to a temperature, or application of an additive or solvent (e.g., comprising hydrogen bonding groups, e.g., Napy, alcohol) to the composition of matter comprising the bottlebrush polymers, reversibly breaks the hydrogen bonds/cross-links (e.g. so that the composition of matter comprising the hydrogen bonds can be formed again).

31. The composition of matter or method of example 30, wherein the solvent/additive breaks the hydrogen bonds/cross-links by forming new hydrogen bonds that are not cross-links/cross-linking.

32. The composition of matter or method of example 30 or 31, wherein to form the hydrogen bonds/cross-links again, the solvent/additive comprising the hydrogen bonding groups needs to be removed.

33. The composition of matter or method of example 30 wherein the hydrogen bonds/cross-links are thermally broken by the increased temperature, and to form the hydrogen bonds/crosslinks again, the temperature needs to be lowered. Thermal breaking does not form new hydrogen bonds.

34. The composition of matter of any of the examples 1-33, wherein the hydrogen bonding groups comprise Napy, or wherein a compound comprising Napy is added as an additive.

### REFERENCES

The following references are incorporated by reference herein
(1) Self, J. L.; Sample, C. S.; Levi, A. E.; Li, K.; Xie, R.; de Alaniz, J. R.; Bates, C. M. Dynamic Bottlebrush Polymer Networks: Self-Healing in Super-Soft Materials. J. Am. Chem. Soc. 2020, 142 (16), 7567-7573. https://doi.org/10.1021/jacs.0c01467.
(2) Folmer, B. J. B.; Sijbesma, R. P.; Versteegen, R. M.; van der Rijt, J. a. J.; Meijer, E. W. Supramolecular Polymer Materials: Chain Extension of Telechelic Polymers Using a Reactive Hydrogen-Bonding Synthon. Adv. Mater. 2000, 12 (12), 874-878. https://doi.org/10.1002/1521-4095(200006)12:12<874::AID-ADMA874>3.0.CO;2-C.
(3) Zhang, Z.; Chen, Q.; H. Colby, R. Dynamics of Associative Polymers. Soft Matter 2018, 14 (16), 2961-2977. https://doi.org/10.1039/C8SM00044A.
(4) Liu, S.; Wu, S.; Chen, Q. Using Coupling Motion of Connecting Ions in Designing Telechelic Ionomers. ACS Macro Lett. 2020, 9 (7), 917-923. https://doi.org/10.1021/acsmacrolett.0c00256.
(5) Wu, S.; Liu, S.; Zhang, Z.; Chen, Q. Dynamics of Telechelic Ionomers with Distribution of Number of Ionic Stickers at Chain Ends. Macromolecules 2019, 52 (6), 2265-2276. https://doi.org/10.1021/acs.macromol.8b01776.
(6) Dashtimoghadam, E.; Fahimipour, F.; Keith, A. N.; Vashahi, F.; Popryadukhin, P.; Vatankhah-Varnosfaderani, M.; Sheiko, S. S. Injectable Non-Leaching Tissue-Mimetic Bottlebrush Elastomers as an Advanced Platform for Reconstructive Surgery. Nat. Commun. 2021, 12 (1), 3961. https://doi.org/10.1038/s41467-021-23962-8.
(7) Vashahi, F.; Martinez, M. R.; Dashtimoghadam, E.; Fahimipour, F.; Keith, A. N.; Bersenev, E. A.; Ivanov, D. A.; Zhulina, E. B.; Popryadukhin, P.; Matyjaszewski, K.; Vatankhah-Varnosfaderani, M.; Sheiko, S. S. Injectable Bottlebrush Hydrogels with Tissue-Mimetic Mechanical Properties. Sci. Adv. 2022. https://doi.org/10.1126/sciadv.abm2469.
(8) Xie, R.; Mukherjee, S.; Levi, A. E.; Reynolds, V. G.; Wang, H.; Chabinyc, M. L.; Bates, C. M. Room Temperature 3D Printing of Super-Soft and Solvent-Free Elastomers. Sci. Adv. 2020, 6 (46), eabc6900. https://doi.org/10.1126/sciadv.abc6900.
(9) Xie, R.; Mukherjee, S.; Levi, A. E.; Self, J. L.; Wang, H.; Chabinyc, M. L.; Bates, C. M. Yielding Behavior of Bottlebrush and Linear Block Copolymers. Macromolecules 2021, 54 (12), 5636-5647. https://doi.org/10.1021/acs.macromol.1c00557.
(10) Choi, C.; Okayama, Y.; Morris, P. T.; Robinson, L. L.; Gerst, M.; Speros, J. C.; Hawker, C. J.; Read de Alaniz, J.; Bates, C. M. Digital Light Processing of Dynamic Bottlebrush Materials. Adv. Funct. Mater. n/a (n/a), 2200883. https://doi.org/10.1002/adfm.202200883.
(11) Nian, S.; Zhu, J.; Zhang, H.; Gong, Z.; Freychet, G.; Zhernenkov, M.; Xu, B.; Cai, L.-H. Three-Dimensional Printable, Extremely Soft, Stretchable, and Reversible Elastomers from Molecular Architecture-Directed Assembly. Chem. Mater. 2021. https://doi.org/10.1021/acs.chemmater.0c04659.
(12) Daniel, W. F. M.; Burdynska, J.; Vatankhah-Varnoosfaderani, M.; Matyjaszewski, K.; Paturej, J.; Rubinstein, M.; Dobrynin, A. V.; Sheiko, S. S. Solvent-Free, Supersoft and Superelastic Bottlebrush Melts and Networks. Nat. Mater. 2016, 15 (2), 183-189. https://doi.org/10.1038/nmat4508.
(13) Arrington, K. J.; Radzinski, S. C.; Drummey, K. J.; Long, T. E.; Matson, J. B. Reversibly Cross-Linkable Bottlebrush Polymers as Pressure-Sensitive Adhesives. ACS Appl. Mater. Interfaces 2018, 10 (31), 26662-26668. https://doi.org/10.1021/acsami.8b08480.
(14) G. Reynolds, V.; Mukherjee, S.; Xie, R.; E. Levi, A.; Atassi, A.; Uchiyama, T.; Wang, H.; L. Chabinyc, M.; M. Bates, C. Super-Soft Solvent-Free Bottlebrush Elastomers for Touch Sensing. Mater. Horiz. 2020, 7 (1), 181-187. https://doi.org/10.1039/C9MH00951E.
(15) Golkaram, M.; Boetje, L.; Dong, J.; Suarez, L. E. A.; Fodor, C.; Maniar, D.; van Ruymbeke, E.; Faraji, S.; Portale, G.; Loos, K. Supramolecular Mimic for Bottlebrush Polymers in Bulk. ACS Omega 2019, 4 (15), 16481-16492. https://doi.org/10.1021/acsomega.9b02126.
(16) Catrouillet, S.; Fonteneau, C.; Bouteiller, L.; Delorme, N.; Nicol, E.; Nicolai, T.; Pensec, S.; Colombani, O. Competition Between Steric Hindrance and Hydrogen Bonding in the Formation of Supramolecular Bottle Brush Polymers. Macromolecules 2013, 46 (19), 7911-7919. https://doi.org/10.1021/ma401167n.
(17) Ruokolainen, J.; Torkkeli, M.; Serimaa, R.; Komanschek, E.; ten Brinke, G.; Ikkala, O. Order-Disorder Transition in Comblike Block Copolymers Obtained by Hydrogen Bonding between Homopolymers and End-Functionalized Oligomers: Poly(4-Vinylpyridine)-Pentadecylphenol. Macromolecules 1997, 30 (7), 2002-2007. https://doi.org/10.1021/ma961609g.
(18) Self, J. L.; Dolinski, N. D.; Zayas, M. S.; Read de Alaniz, J.; Bates, C. M. Brønsted-Acid-Catalyzed Exchange in Polyester Dynamic Covalent Networks. ACS Macro Lett. 2018, 7 (7), 817-821. https://doi.org/10.1021/acsmacrolett.8b00370.
(19) Feldman, K. E.; Kade, M. J.; Meijer, E. W.; Hawker, C. J.; Kramer, E. J. Model Transient Networks from Strongly Hydrogen-Bonded Polymers. Macromolecules 2009, 42 (22), 9072-9081. https://doi.org/10.1021/ma901668w.
(20) Zhang, Z.; Liu, C.; Cao, X.; Gao, L.; Chen, Q. Linear Viscoelastic and Dielectric Properties of Strongly Hydrogen-Bonded Polymers near the Sol-Gel Transition. Macromolecules 2016, 49 (23), 9192-9202. https://doi.org/10.1021/acs.macromol.6b02017.
(21) Cao, Z.; Daniel, W. F. M.; Vatankhah-Varnosfaderani, M.; Sheiko, S. S.; Dobrynin, A. V. Dynamics of Bottlebrush Networks. Macromolecules 2016, 49 (20), 8009-8017. https://doi.org/10.1021/acs.macromol.6b01358.
(22) Chen, Q.; Tudryn, G. J.; Colby, R. H. Ionomer Dynamics and the Sticky Rouse Model. J. Rheol. 2013, 57 (5), 1441-1462. https://doi.org/10.1122/1.4818868.
(23) Abbasi, M.; Faust, L.; Riazi, K.; Wilhelm, M. Linear and Extensional Rheology of Model Branched Polystyrenes: From Loosely Grafted Combs to Bottlebrushes. Macromolecules 2017, 50 (15), 5964-5977. https://doi.org/10.1021/acs.macromol.7b01034.
(24) Dalsin, S. J.; Hillmyer, M. A.; Bates, F. S. Linear Rheology of Polyolefin-Based Bottlebrush Polymers. Macromolecules 2015, 48 (13), 4680-4691. https://doi.org/10.1021/acs.macromol.5b01153.
(25) Liang, H.; Sheiko, S. S.; Dobrynin, A. V. Supersoft and Hyperelastic Polymer Networks with Brushlike Strands. Macromolecules 2018, 51 (2), 638-645. https://doi.org/10.1021/acs.macromol.7b02555.
(26) Mukherjee, S.; Xie, R.; Reynolds, V. G.; Uchiyama, T.; Levi, A. E.; Valois, E.; Wang, H.; Chabinyc, M. L.; Bates, C. M. Universal Approach to Photo-Crosslink Bottlebrush Polymers. Macromolecules 2020, 53 (3), 1090-1097. https://doi.org/10.1021/acs.macromol.9b02210.
(27) Yu, X.; Cao, X.; Chen, Q. Rheological Properties of Sulfonated Polystyrene Ionomers at High-Ion Contents. Rheol. Acta 2021. https://doi.org/10.1007/s00397-021-01265-5.
(28) Chen, Q.; Liang, S.; Shiau, H.; Colby, R. H. Linear Viscoelastic and Dielectric Properties of Phosphonium Siloxane Ionomers. ACS Macro Lett. 2013, 2 (11), 970-974. https://doi.org/10.1021/mz400476w.
(29) Shen, Z.; Ye, H.; Wang, Q.; Kroger, M.; Li, Y. Sticky Rouse Time Features the Self-Adhesion of Supramolecular Polymer Networks. Macromolecules 2021. https://doi.org/10.1021/acs.macromol.1c00335.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A composition of matter, comprising:
a plurality of bottlebrush polymers, each of the bottlebrush polymers comprising:
a backbone including a plurality of monomer units; and
a plurality of side-chains attached to the backbone; and
one or more of the side-chains each comprising a linker compound terminated with a cross-linker compound comprising a hydrogen bonding group; and
a plurality of hydrogen bonds forming reversible bonds between the hydrogen bonding groups of cross-linker compounds in different ones of the bottlebrush polymers, so as to form cross-links between different ones of the bottlebrush polymers; and
wherein a concentration of the hydrogen bonds is tuned and the one or more of the side-chains each have at least one of a glass transition temperature T_{g} or a melting temperature Tₘ below minus twenty degrees Celsius so that the composition of matter is amorphous and/or comprises an elastomer having at least one of a modulus less than 1 MPa at a temperature 23° C. or a melting temperature Tₘ less than 30° C.

2. The composition of matter of claim 1, wherein −140° C.≤Tm, Tg<20° C.

3. The composition of matter of claim 1, wherein the cross-linker compounds are each a 2-ureido-4[1H]-pyrimidinone of the structure

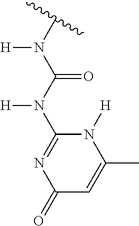 [SMILES: *NC(=O)Nc1nc(=O)cc(C)[nH]1]

4. The composition of matter of claim 1, wherein one or more of the cross-linker compounds are terminated by the hydrogen bonding group comprising an oxygen, nitrogen, fluorine, sulfur or other moiety capable of attaching to a reversible hydrogen bonding moiety.

5. The composition of matter of claim 1, wherein the side-chain comprises a poly(4-methylcaprolactone).

6. (canceled)

7. The composition of matter of claim 1, wherein the monomer units before polymerization comprise a norbornene, a styrene, an acrylate, a (meth)acrylate, or an acrylamide.

8. The composition of matter of claim 1, wherein the backbone has the structure: 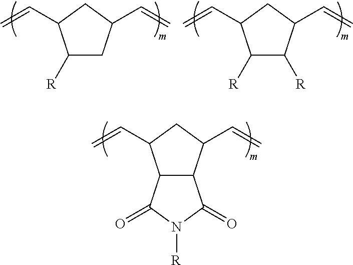
and m is an integer and R is a side-chain.

9. The composition of matter of claim 1, wherein the backbone has the structure: 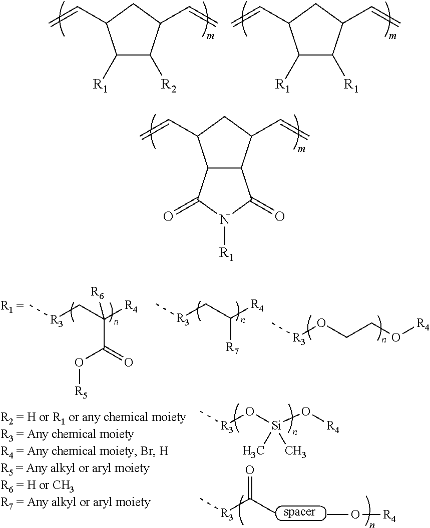
wherein R₄ can be any chemical moiety, Br, H or crosslinker; the spacer can be any alkyl or aryl moiety, including CH₂CH(R₅)CH₂CH₂CH₂, CH₂CH₂CH(CH₃)CH₂CH₂, CH₂CH₂CH(R₅)CH₂CH₂, CH₂CH₂C(R₅)₂CH₂CH₂, CH₂CH₂CH₂CH(R₅)CH₂, CH₂CH₂CH₂CH₂CH(R₅), CH₂CH(R₅)CH₂CH₂, CH₂CH₂CH₂CH(R₅) and CH₂CH₂CH(R₅)CH₂. and m, n are integers.

10. The composition of matter of claim 1, wherein the side-chains comprise at least one of a polyester, an oligomeric ester, a polyether, an oligomeric ethylene oxide, a poly(ethylene oxide), an oligomeric propylene oxide, a poly(propylene oxide), an oligomeric propylene, polypropylene, an oligomeric isobutylene, a polyisobutylene, a poly(dimethylsiloxane), an oligomeric dimethylsiloxane, an oligomeric acrylate, polyacrylate, or a polystyrene.

11. The composition of matter of claim 1, wherein the cross-linker compounds comprise at least one of a N-propylthymine, an aminopyridine, a diaminopyridine, an acetylpyridine, a diacetylaminopyridine, an aminopyrimidine, diamonopyrimidine, an acetylpyrimidinone, a diacetylpyrimidinone, an aminotriazine, a diaminotriazine, an ureidotriazine, an ureidopyrimidinone, a N-carbamoyl squaramide, a 2,7-bis(acylamino)-1,8-naphthyridine, a pyridylurea, a dipyridylurea, or a dipyrimidinylamine.

12. The composition of matter of claim 1, wherein T_{g}, Tₘ, and an amount of the crosslinker compounds in the bottlebrush polymers are selected such that the bottlebrush polymers form an elastomer with a uniaxial tensile elastic modulus in a range of 100 Pa to 1 MPa at a temperature in a range of −20° C. to 50° C. or −20° C. to 40° C.

13. The composition of claim 1, further comprising:
an amount of the crosslinker compounds in the composition of matter selected or tuned such that the composition of matter has a shear modulus in a range of 100 Pa to 1 MPa as measured by a rheometer when strain rate is in a range of 1 s⁻¹ to 5 s⁻¹, the tensile strain is applied at a frequency in a range of 0.1 to 100 rad/s using a strain amplitude of 1%≤strain amplitude≤5% in a temperature range of −40° C. to 100° C., or as measured by a texture analyzer.

14. An elastomer, actuator, adhesive, or pressure sensor comprising the composition of matter of claim 1.

15. The composition of matter of claim 1 having the structure: 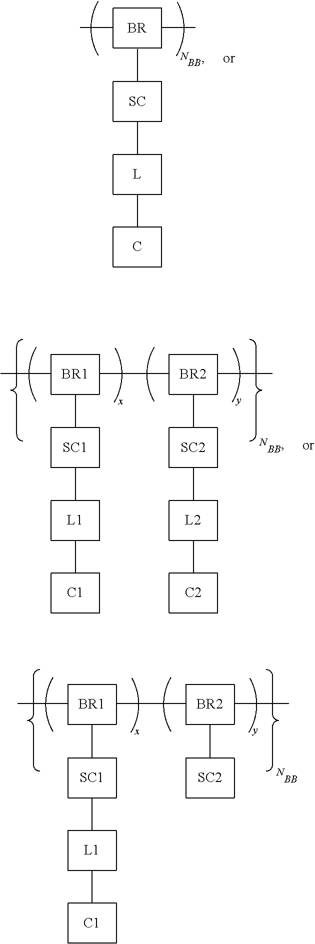
wherein:
BR, BR1, BR2 comprise the backbone monomer unit, BR1 and BR2 can be different or the same;
SC, SC1, SC2 comprise a linker side-chain moiety for linking the backbone to the linker compound, SC1 and SC2 can be different or the same;
L, L1, L2 comprise the linker compound, L1 and L2 can be different or the same; and
C, C1, C2 comprise the crosslinker compound, C1 and C2 can be different or the same.

16. The composition of matter of claim 1, wherein the hydrogen bonds are such that the composition of matter reversibly transitions between an elastic solid and a viscoelastic liquid upon repeated heating and cooling cycles.

17. An adhesive comprising the composition of matter of claim 16, wherein a degree of adhesion is tuned by the concentration of the hydrogen bonds.

18. The composition of matter of claim 14, wherein the elastomer is self-healing between a temperature of 35° C. and a temperature below a decomposition temperature of the elastomer, and the self-healing is characterized by the elastomer reversibly transitioning between the elastic solid and the viscoelastic liquid upon repeated heating to the temperature of at least 35° C. and cooling to a temperature below 35° C.

19. The composition of matter of claim 18, further comprising a composition of the hydrogen bonding groups and a concentration of the hydrogen bonding groups selected to obtain the self healing temperature.

20. An additive comprising the composition of matter of claim 1.

21. A method of making the composition of matter of claim 1 comprising:
providing an amount of the cross-linker compounds in the bottlebrush polymers to obtain a desired elastic modulus of the composition of matter in range where the elastic modulus of the composition of matter is a linear function of the amount of cross linker compound.

22. The method of claim 21, wherein:
the function is a straight line characterized by a first fitting parameter (a) and a second fitting parameter (b),
the first fitting parameter is proportional to the slope of the straight line and a y-intercept of the straight line is proportional to the second fitting parameter, and
the first fitting parameter and the second fitting parameter are extracted by fitting the measured elastic moduli with the function for various compositions of matter having different side-chain and backbone lengths and crosslinker loadings.
